SEQUENCE LISTING (2 sequences)

SEQ ID NO: 1 - DNA, 1550 bp, Bacillus pumilus
tcggagagtttgatcctggctcaggacgaacgctggcggcgtgcctaatacatgcaagtcgagcgaacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccataaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacctttatggagccagccgccgaaggtggggcagatgattggggtgaagtcgtaacaaggtagccgtatcggaaggtgcggctggatcacctcctttctaa

SEQ ID NO: 2 - DNA, 1515 bp, Bacillus sphaericus
cctggctcaggacgaacgctggcggcgtgcctaatacatgcaagtcgagcgaacagagaaggagcttgctcctttgacgttagcggcggacgggtgagtaacacgtgggcaacctaccctatagtttgggataactccgggaaaccggggctaataccgaataatctcttgtccctcatgggacaatactgaaagacggtttcggctgtcgctataggatgggcccgcggcgcattagctagttggtgaggtaacggctcaccaaggcaacgatgcgtagccgacctgagagggtgatcggccacactgggactgagacacggcccagactcctacgggaggcagcagtagggaatcttccacaatgggcgaaagcctgatggagcaacgccgcgtgagtgaagaaggatttcggttcgtaaaactctgttgtaagggaagaacaagtacagtagtaactggctgtaccttgacggtaccttattagaaagccacggctaactacgtgccagcagccgcggtaatacgtaggtggcaagcgttgtccggaattattgggcgtaaagcgcgcgcaggtggtttcttaagtctgatgtgaaagcccacggctcaaccgtggagggtcattggaaactgggagacttgagtgcagaagaggatagtggaattccaagtgtagcggtgaaatgcgtagagatttggaggaacaccagtggcgaaggcgactatctggtctgtaactgacactgaggcgcgaaagcgtggggagcaaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcccgttgaccactgtagagatatggttttcccttcggggacaacggtgacaggtggtgcatggttgtcgtcagctcgtgtcgtgagatgttgggttaagtcccgcaacgagcgcaacccttgatcttagttgccatcatttagttgggcactctaaggtgactgccggtgacaaaccggaggaaggtggggatgacgtcaaatcatcatgccccttatgacctgggctacacacgtgctacaatggacgatacaaacggttgccaactcgcgagagggagctaatccgataaagtcgttctcagttcggattgtaggctgcaactcgcctacatgaagccggaatcgctagtaatcgcggatcagcatgccgcggtgaatacgttcccgggccttgtacacaccgcccgtcacaccacgagagtttgtaacacccgaagtcggtgaggtaaccttttggagccagccgccgaaggtgggatagatgattggggtgaagtcgtaacaaggtagccgtatcggaaggt

(19) United States
(12) Patent Application Publication
(10) Pub. No.: US 2020/0187507 A1
(43) Pub. Date: Jun. 18, 2020

(54) INOCULANTS INCLUDING PLANT GROWTH PRODUCING RHIZOBACTERIA (PGPR) AND INSECTIDES FOR PROMOTING PLANT GROWTH AND HEALTH

(71) Applicant: Auburn University, Auburn, AL (US)

(72) Inventors: David W. Held, Auburn, AL (US); R. Murphey Coy, Auburn, AL (US); John A. McInroy, Auburn, AL (US); Joseph W. Kloepper, Auburn, AL (US)

(73) Assignee: Auburn University, Auburn, AL (US)

(21) Appl. No.: 16/706,289

(22) Filed: Dec. 6, 2019

Related U.S. Application Data
(60) Provisional application No. 62/776,080, filed on Dec. 6, 2018.
(60) Provisional application No. 62/776,093, filed on Dec. 6, 2018.

(51) Int. Cl. A01N 63/23; A01N 25/00; A01G 7/06

(52) U.S. Cl. CPC A01N 63/23; A01G 7/06; A01N 25/006

(57) ABSTRACT

Disclosed are compositions that include a plant growth promoting rhizobacteria (PGPR) and an insecticide. The disclosed compositions may be formulated as incoculants for promoting growth and/or health in plants. The disclosed compositions may be administered to a plant in order to increase tolerance to stress caused by root-feeding pests and/or drought and may include additional components such as fertilizers.

### CROSS-REFERENCED TO RELATED PATENT APPLICATIONS

The present application claims the benefit of priority under 35 U.S.C. § 119(e) to U.S. Provisional Application 62/776,093, filed on Dec. 6, 2018 and U.S. Provisional Application No. 62/776,080, filed on Dec. 6, 2018; the contents of which are incorporate herein by reference in their entireties.

### REFERENCE TO A SEQUENCE LISTING SUBMITTED VIA EFS-WEB

The content of the ASCII text file of the sequence listing named “169996_00449_ST25.txt” which is 4.56 kb in size was created on Dec. 5, 2019 and electronically submitted via EFS-Web herewith the application is incorporated herein by reference in its entirety.

### FIELD

The present subject matter relates to the field of plant growth-promoting rhizobacteria (PGPR). In particular, the present subject matter relates to compositions comprising one or more PGPR and one or more insecticides. The disclosed composition may be administered to promote growth and health in plants.

### BACKGROUND

Plant growth promoting rhizobacteria (PGPR) represent a wide range of root-colonizing bacteria whose application often is associated with increased rates of plant growth (Kloepper, 1992; Zehnder et al., 1997), suppression of soil pathogens (Schippers et al., 1987), and the induction of systemic resistance against insect pests (Kloepper et al., 1999; Ryu et al., 2004). However, few studies have examined whether PGPR applications increase stress tolerance in plants including stress from root-feeding pests and drought. Here, the inventors studied whether inoculation of bermudagrass with PGPR can increase tolerance in plants to root-feeding pests and if PGPR are compatible with insecticides commonly used for controlling root-feeding pests in plants. The inventors also examined whether PGPR can increase tolerance to drought. The results of the inventors' studies suggest that PGPR are compatible with insecticides and that compositions comprising PGPR and insecticides can be formulated as inoculants for plants which can be administered to promote growth and health.

### SUMMARY

Disclosed are compositions comprising one or more plant growth promoting rhizobacteria (PGPR) and one or more insecticides. The PGPR may be a single strain, species, or genus of bacteria or may comprise a mixture of bacterial strains, species, or genera. The insecticide may comprises a single insecticide or may comprise a mixture of insecticides.

The disclosed compositions may be formulated as inoculants for plants and may be administered to plants in order to promote growth and health. In particular, the disclosed compositions may be administered to plants in order to increase tolerance to stress, which may include but is not limited to stress from root-feeding pests and stress from drought. The disclosed compositions optionally may include additional components for promoting growth and health in plants such as fertilizers. The compositions optionally comprise a carrier, diluent, and/or excipient.

### BRIEF DESCRIPTION OF THE FIGURES

FIG. 1. Mean (±SEM) log populations of Bacillus pumilus AP 7 mixed with Talstar® P Professional (FMC, Bifenthrin, high and low label rate), Termidor® SC (BASF Corp., Fipronil, high and low label rate), and Merit® 2F (Bayer Environmental Sciences, Imidacloprid) over two weeks.

FIG. 2. Mean (±SEM) log populations of Bacillus pumilus AP 18 mixed with Talstar® P Professional (FMC, Bifenthrin, high and low label rate), Termidor® SC (BASF Corp., Fipronil, high and low label rate), and Merit® 2F (Bayer Environmental Sciences, Imidacloprid) over two weeks.

FIG. 3. Mean (±SEM) log populations of Bacillus sphaericus AP 282 mixed with Talstar® P Professional (FMC, Bifenthrin, high and low label rate), Termidor® SC (BASF Corp., Fipronil, high and low label rate), and Merit® 2F (Bayer Environmental Sciences, Imidacloprid) over two weeks.

FIG. 4. Mean (±SEM) of top growth (g) of Trial 2 Tifway bermudagrass foliage from PVC arenas infested with tawny mole crickets for 4 wk. Treatments evaluated untreated, non-infested; untreated, infested; PGPR treated, infested, or fertilized, infested grasses. Top: foliage top growth above 3.7 cm fresh mass; Bottom: foliage top growth above 3.7 cm dry mass.

FIG. 5. Mean (±SEM) of curative tawny mole cricket damage ratings based on Cobb and Mack (1989) evaluating untreated, PGPR-treated, bifenthrin treated, and PGPR+bifengthirn over 56 days.

FIG. 6. Top: Ability for nitrogen fixation by rhizobacteria is indicated by pellicle (white membrane) formation on NFb media by Bacillus pumilus AP 7 compared to control (uninoculated) media. Bottom: Ability of siderophore production by bacteria is indicated by the orange halo from single colonies of Brevibacillus brevis AP 217 plated on CAS media compared to control (uninoculated).

FIG. 7. Drought recovery of LaPaloma bermudagrass in 100% sand after 21 days without water under greenhouse conditions. Top left: Blend 20+50% of nitrogen after 1 wk recovery, Blend 20+50% Nitrogen after 3 wk recovery. Top (8) plants in each container were retreated post drought, bottom (8) plants were not retreated. Bottom: All LaPaloma treatments during drought recovery. Front left: Blend 20, Control, Nitrogen; Back left: Blend 20+50% Nitrogen, 50% Nitrogen.

FIG. 8. Bacillus pumilus AP 7 rifampicin mutant mean (±SEM) log populations CFU/g (0.035 oz) of tissue in common bermudagrass (Cynodon dactylon) grown under field conditions in Marvyn loamy sand soil (pH 7.3). Grasses were treated with bacterial populations of 1.98×10⁸ CFU/oz at a rate of 16.9 oz of bacteria per 10.76 ft². Applications were followed by 0.5 in of water. Populations sampled the rhizoplane (root surface), rhizosphere (roots and soil), and endophytic (roots and shoots) colonization for 12 weeks.

FIG. 9. Mean (±SEM) log populations of Bacillus pumilus AP 7 mixed with Bifenthrin, (high and low label rate), Fipronil (high and low label rate), Imidacloprid, and Imidacloprid and Clothianidin over two weeks

FIG. 10. Mean (±SEM) log populations of Bacillus pumilus AP 7 mixed with Ferti-lome® Tree & Shrub Systemic Insect Drench (Voluntary Purchasing Groups, Inc, Imidacloprid), Merit® 2F (Bayer Environmental Sciences, Imidacloprid), and Bayer Advanced 12 Month Tree and Shrub Protect II® (Bayer Environmental Sciences, Imidacloprid and Clothianidin) over two weeks.

FIG. 11. Mean (±SEM) log populations of Bacillus pumilus AP 18 mixed with Ferti-lome® Tree & Shrub Systemic Insect Drench (Voluntary Purchasing Groups, Inc, Imidacloprid), Merit® 2F (Bayer Environmental Sciences, Imidacloprid), and Bayer Advanced 12 Month Tree and Shrub Protect II® (Bayer Environmental Sciences, Imidacloprid and Clothianidin) over two weeks.

FIG. 12. Mean (±SEM) log populations of Bacillus sphaericus AP 282 mixed with Ferti-lome® Tree & Shrub Systemic Insect Drench (Voluntary Purchasing Groups, Inc, Imidacloprid), Merit® 2F (Bayer Environmental Sciences, Imidacloprid), and 12 Month Tree and Shrub Protect II® (Bayer Environmental Sciences, Imidacloprid and Clothianidin) over two weeks.

FIG. 13. Mean (±SEM) of top growth (g) of KY 32 tall fescue foliage from Styrofoam cup arenas infested with Japanese beetle grubs for 4 wk. Treatments evaluated untreated, PGPR-treated, or fertilized grasses. Top: foliage top growth above 5.0 cm fresh mass; Bottom: foliage top growth above 5.0 cm dry mass.

FIG. 14. Mean (±SEM) of top growth (g) of Tifway bermudagrass foliage from plastic pot arenas infested with tawny mole crickets for 8 wk. Treatments evaluated untreated, PGPR-treated, or fertilized grasses. Top: foliage top growth above 3.7 cm fresh mass; Bottom: foliage top growth above 3.7 cm dry mass.

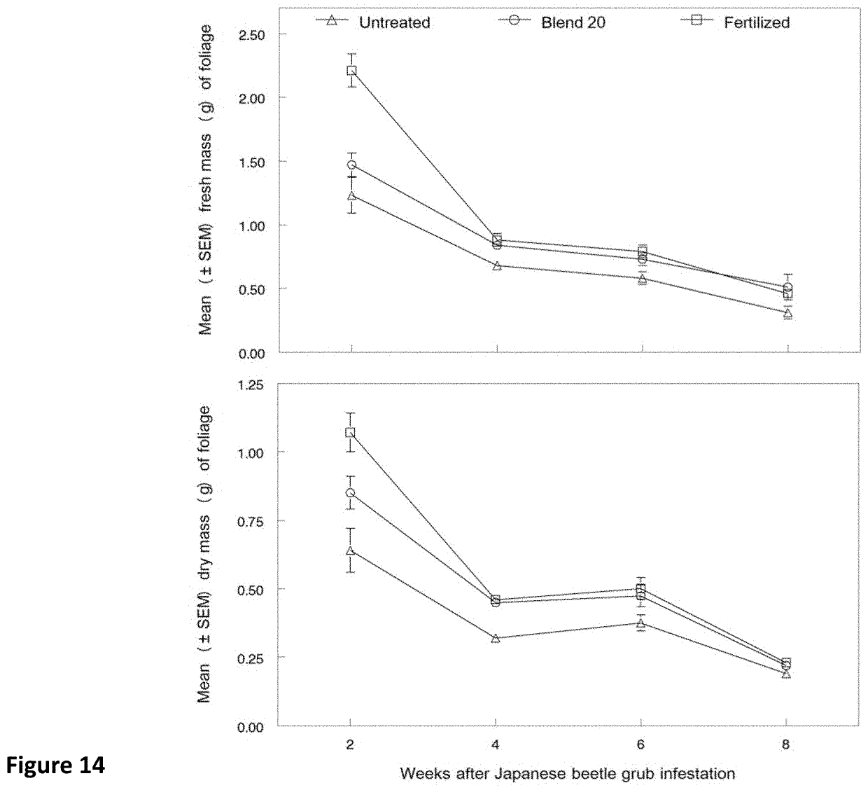

### DETAILED DESCRIPTION

The disclosed subject matter may be further described using definitions and terminology as follows. The definitions and terminology used herein are for the purpose of describing particular embodiments only, and are not intended to be limiting

As used in this specification and the claims, the singular forms “a,” “an,” and “the” include plural forms unless the context clearly dictates otherwise. For example, the term “a PGPR” and “an insecticide” should be interpreted to mean “one or more PGPRs” and “one or more insecticides,” respectively, unless the context clearly dictates otherwise. As used herein, the term “plurality” means “two or more.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a composition comprising at least one of A, B and C” would include but not be limited to a composition that comprises A alone, B alone, C alone, A and B together, A and C together, B and C together, and/or A, B, and C together). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or ‘B or “A and B.”

All language such as “up to,” “at least,” “greater than,” “less than,” and the like, include the number recited and refer to ranges which can subsequently be broken down into subranges as discussed above.

A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use and aspect of a described embodiment or feature contained in the same, or a definitive decision to use a specific skill regarding a described embodiment or feature contained in the same. In this latter context, the modal verb “may” has the same meaning and connotation as the auxiliary verb “can.”

Plant Growth Promoting Rhizobacteria for Promoting Growth and Health in Plants

The term “plant” as utilized herein should be interpreted broadly and may include angiosperms and gymnosperms, dicots and monocots, and trees. The term “plant” should be interpreted to include grasses, which may include, but are not limited to bermudagrasses (Cynodon spp.), bahiagrass (Paspalum notatum Flugge), Saint Augustinegrass (Stenotaphrum secundatum (Walt) Kuntz), centipedegrass (Eremochloa ophiuroides (Munro) Hack), and zoysiagrass (Zoysia spp.).

The term “plant growth promoting rhizobacteria” or “PGPR” refers to a group of bacteria that colonize plant roots, and in doing so, promote plant growth and/or reduce disease or damage from predators. Bacteria that are PGPR may belong to genera including, but not limited to Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, and Lysinibacillus. In particular, PGPR may include Bacillus spp. as disclosed herein, such as Bacillus pumilus, Bacillus sphaericus, strains thereof, and mixtures or blends thereof.

The presently disclosed PGPR may be formulated as a composition which may be utilized as an inoculant for a plant. The term “inoculant” means a preparation that includes an isolated culture of a PGPR and optionally a carrier, which may include a biologically acceptable medium.

The presently disclosed PGPR may be isolated or substantially purified. The terms “isolated” or “substantially purified” refers to PGPR that have been removed from a natural environment and have been isolated or separated, and are at least 60% free, preferably at least 75% free, and more preferably at least 90% free, even more preferably at least 95% free, and most preferably at least 100% free from other components with which they were naturally associated. An “isolated culture” refers to a culture of the PGPR that does not include significant amounts of other materials such as other materials which normally are found in soil in which the PGPR grows and/or from which the PGPR normally may be obtained. An “isolated culture” may be a culture that does not include any other biological, microorganism, and/or bacterial species in quantities sufficient to interfere with the replication of the “isolated culture.” Isolated cultures of PGPR may be combined to prepare a mixed culture of PGPR.

The genus Bacillus as used herein refers to a genus of Gram-positive, rod-shaped bacteria which are members of the division Firmicutes. Under stressful environmental conditions, the Bacillus bacteria produce oval endospores that can stay dormant for extended periods. Bacillus bacteria may be characterized and identified based on the nucleotide sequence of their 16S rRNA or a fragment thereof (e.g., approximately a 1000 nt, 1100 nt, 1200 nt, 1300 nt, 1400 nt, or 1500 nt fragment of 16S rRNA or corresponding rDNA nucleotide sequence). Bacillus bacteria may include, but are not limited to B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altitudinis, B. alveayuensis, B. amyloliquefaciens, B. anthracis, B. aquimaris, B. arsenicus, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyticus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. fastidiosus, B. firmus, B. flexus, B. foraminis, B. fordii, B. fortis, B. fumarioli, B. funiculus, B. galactosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. krulwichiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus, B. qingdaonensis, B. rigui, B. ruris, B. safensis, B. salarius, B. saliphilus, B. schlegelii, B. selenatarsenatis, B. selenitireducens, B. seohaeanensis, B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. thermoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and mixtures or blends thereof.

Suitable Bacillus bacteria may include bacteria comprising a 16S rRNA having a sequence having at least 90%, 91%, 92%, 93%, 94%, 95%, 96%, 97%, 98%, or 99% sequence identity to the rRNA (or rDNA) sequence of Bacillus pumilus (SEQ ID NO:1) and/or Bacillus sphaericus (SEQ ID NO:2).

| SEQ ID NO: 1 | |
|---|---|
| Bacillus pumilus 16S rDNA | |
| 1 | tcggagagtt tgatcctggc tcaggacgaa cgctggcggc gtgcctaata catgcaagtc |
| 61 | gagcgaacag aagggagctt gctcccggat gttagcggcg gacgggtgag taacacgtgg |
| 121 | gtaacctgcc tgtaagactg ggataactcc gggaaaccgg agctaatacc ggatagttcc |
| 181 | ttgaaccgca tggttcaagg atgaaagacg gtttcggctg tcacttacag atggacccgc |
| 241 | ggcgcattag ctagttggtg gggtaatggc tcaccaaggc gacgatgcgt agccgacctg |
| 301 | agagggtgat cggccacact gggactgaga cacggcccag actcctacgg gaggcagcag |
| 361 | tagggaatct tccgcaatgg acgaaagtct gacggagcaa cgccgcgtga gtgatgaagg |
| 421 | ttttcggatc gtaaagctct gttgttaggg aagaacaagt gcgagagtaa ctgctcgcac |
| 481 | cttgacggta cctaaccaga aagccacggc taactacgtg ccagcagccg cggtaatacg |
| 541 | taggtggcaa gcgttgtccg gaattattgg gcgtaaaggg ctcgcaggcg gtttcttaag |
| 601 | tctgatgtga aagcccccgg ctcaaccggg gagggtcatt ggaaactggg aaacttgagt |
| 661 | gcagaagagg agagtggaat tccacgtgta gcggtgaaat gcgtagagat gtggaggaac |
| 721 | accagtggcg aaggcgactc tctggtctgt aactgacgct gaggagcgaa agcgtgggga |
| 781 | gcgaacagga ttagataccc tggtagtcca cgccgtaaac gatgagtgct aagtgttagg |
| 841 | gggtttccgc cccttagtgc tgcagctaac gcattaagca ctccgcctgg ggagtacggt |
| 901 | cgcaagactg aaactcaaag gaattgacgg gggcccgcac aagcggtgga gcatgtggtt |
| 961 | taattcgaag caacgcgaag aaccttacca ggtcttgaca tcctctgaca accctagaga |
| 1021 | tagggctttc ccttcgggga cagagtgaca ggtggtgcat ggttgtcgtc agctcgtgtc |
| 1081 | gtgagatgtt gggttaagtc ccgcaacgag cgcaaccctt gatcttagtt gccagcattt |
| 1141 | agttgggcac tctaaggtga ctgccggtga caaaccggag gaaggtgggg atgacgtcaa |
| 1201 | atcatcatgc cccttatgac ctgggctaca cacgtgctac aatggacaga acaaagggct |
| 1261 | gcgagaccgc aaggtttagc caatcccata aatctgttct cagttcggat cgcagtctgc |
| 1321 | aactcgactg cgtgaagctg gaatcgctag taatcgcgga tcagcatgcc gcggtgaata |
| 1381 | cgttcccggg ccttgtacac accgcccgtc acaccacgag agtttgcaac acccgaagtc |
| 1441 | ggtgaggtaa cctttatgga gccagccgcc gaaggtgggg cagatgattg gggtgaagtc |
| 1501 | gtaacaaggt agccgtatcg gaaggtgcgg ctggatcacc tcctttctaa |
| SEQ ID NO: 2 | |
| Bacillus sphaericus 16S rDNA | |
| 1 | cctggctcag gacgaacgct ggcggcgtgc ctaatacatg caagtcgagc gaacagagaa |
| 61 | ggagcttgct cctttgacgt tagcggcgga cgggtgagta acacgtgggc aacctaccct |
| 121 | atagtttggg ataactccgg gaaaccgggg ctaataccga ataatctctt gtccctcatg |
| 181 | ggacaatact gaaagacggt ttcggctgtc gctataggat gggcccgcgg cgcattagct |
| 241 | agttggtgag gtaacggctc accaaggcaa cgatgcgtag ccgacctgag agggtgatcg |
| 301 | gccacactgg gactgagaca cggcccagac tcctacggga ggcagcagta gggaatcttc |
| 361 | cacaatgggc gaaagcctga tggagcaacg ccgcgtgagt gaagaaggat ttcggttcgt |
| 421 | aaaactctgt tgtaagggaa gaacaagtac agtagtaact ggctgtacct tgacggtacc |
| 481 | ttattagaaa gccacggcta actacgtgcc agcagccgcg gtaatacgta ggtggcaagc |
| 541 | gttgtccgga attattgggc gtaaagcgcg cgcaggtggt ttcttaagtc tgatgtgaaa |
| 601 | gcccacggct caaccgtgga gggtcattgg aaactgggag acttgagtgc agaagaggat |
| 661 | agtggaattc caagtgtagc ggtgaaatgc gtagagattt ggaggaacac cagtggcgaa |
| 721 | ggcgactatc tggtctgtaa ctgacactga ggcgcgaaag cgtggggagc aaacaggatt |
| 781 | agataccctg gtagtccacg ccgtaaacga tgagtgctaa gtgttagggg gtttccgccc |
| 841 | cttagtgctg cagctaacgc attaagcact ccgcctgggg agtacggtcg caagactgaa |
| 901 | actcaaagga attgacgggg gcccgcacaa gcggtggagc atgtggttta attcgaagca |
| 961 | acgcgaagaa ccttaccagg tcttgacatc ccgttgacca ctgtagagat atggttttcc |
| 1021 | cttcggggac aacggtgaca ggtggtgcat ggttgtcgtc agctcgtgtc gtgagatgtt |
| 1081 | gggttaagtc ccgcaacgag cgcaaccctt gatcttagtt gccatcattt agttgggcac |
| 1141 | tctaaggtga ctgccggtga caaaccggag gaaggtgggg atgacgtcaa atcatcatgc |
| 1201 | cccttatgac ctgggctaca cacgtgctac aatggacgat acaaacggtt gccaactcgc |
| 1261 | gagagggagc taatccgata aagtcgttct cagttcggat tgtaggctgc aactcgccta |
| 1321 | catgaagccg gaatcgctag taatcgcgga tcagcatgcc gcggtgaata cgttcccggg |
| 1381 | ccttgtacac accgcccgtc acaccacgag agtttgtaac acccgaagtc ggtgaggtaa |
| 1441 | ccttttggag ccagccgccg aaggtgggat agatgattgg ggtgaagtcg taacaaggta |
| 1501 | gccgtatcgg aaggt |

“Percentage sequence identity” may be determined by aligning two sequences of equivalent length using the Basic Local Alignment Search Tool (BLAST) available at the National Center for Biotechnology Information (NCBI) website (i.e., “bl2seq” as described in Tatiana A. Tatusova, Thomas L. Madden (1999), “Blast 2 sequences—a new tool for comparing protein and nucleotide sequences”, FEMS Microbiol Lett. 174:247-250, incorporated herein by reference in its entirety). For example, percentage sequence identity between SEQ ID NO:1 and SEQ ID NO:2 may be determined by aligning these two sequences using the online BLAST software provided at the NCBI website.

“Percentage sequence identity” between two deoxyribonucleotide sequences may also be determined using the Kimura 2-parameter distance model which corrects for multiple hits, taking into account transitional and transversional substitution rates, while assuming that the four nucleotide frequencies are the same and that rates of substitution do not vary among sites (Nei and Kumar, 2000) as implemented in the MEGA 4 (Tamura K, Dudley J, Nei M & Kumar S (2007) MEGA4: Molecular Evolutionary Genetics Analysis (MEGA) software version 4.0. Molecular Biology and Evolution 24:1596-1599), preferably version 4.0.2 or later. The gap opening and extension penalties are set to 15 and 6.66 respectively. Terminal gaps are not penalized. The delay divergent sequences switch is set to 30. The transition weight score is 35 set to 0.5, as a balance between a complete mismatch and a matched pair score. The DNA weight matrix used is the IUB scoring matrix where x's and n's are matches to any IUB ambiguity symbol, and all matches score 1.9, and all mismatched score O.

The disclosed compositions may comprise a suitable concentration of PGPR, for example, a suitable concentration for promoting growth and/or health which the compositions are administered to a plant. In some embodiments, the compositions comprise one or more PGPR at a concentration of at least about 1×10⁵, 1×10⁶, 1×10⁷, 1×10⁸, 1×10⁹, 1×10¹⁰, 1×10¹¹, 1×10¹² colony forming units (CFU)/ml or within a concentration range bounded by any of these concentrations. The disclosed compositions may comprise a single PGPR or the disclosed compositions may comprise a mixture of different PGPR, where each PGPR of the mixture may be present at a different concentration in the composition.

The presently disclosed compositions comprising one or more PGPR and/or one or more insecticides insect may be utilized to treat plants and promote growth and/or health in the treated plants. For example, the presently disclosed compositions may be formulated as an inoculant for treating plants. The methods of treatment contemplated herein may include treating a plant directly including roots of the plant directly. The methods of treatment contemplated herein may include treating seeds of the plant, e.g., prior to the seeds being planted to produce a treated plant. The methods contemplated herein also may include treating a plant indirectly, for example, by treating soil or the environment surrounding the plant (e.g., in-furrow granular or liquid applications). Suitable methods of treatment may include applying an inoculant including one or more PGPR and one or more insecticides via high or low pressure spraying, drenching, and/or injection. Plant seeds may be treated by applying low or high pressure spraying, coating, immersion, and/or injection. After plant seeds have been thusly treated, the seeds may be planted and cultivated to produce plants. Plants propagated from such seeds may be further treated with one or more applications. Suitable application concentrations may be determined empirically. In some embodiments where the compositions comprising the one or more PGPR and the one or more insecticides are applied as a spray to plants, suitable application concentrations may include spraying 10⁶-10¹⁸ colony forming units (cfu) per hectare of plants, more commonly 10⁷-10¹⁵ cfu per hectare. For coated seeds, in some embodiments, suitable application concentrations may be between 10²-10⁸ cfu per seed, preferably 10⁴-10⁷ cfu per seed. In other embodiments, the PGPR may be applied as a seedling root-dip or as a soil drench at a concentration of about 10²-10¹² cfu/ml, 10⁴-10¹⁰ cfu/ml, or about 10⁶-10⁸ cfu/ml.

The compositions comprising the one or more PGPR and the one or more insecticides further may comprise a suitable carrier (e.g., such as an inoculum). Suitable carriers may include, but are not limited to, water or other aqueous solutions, slurries, solids (e.g., peat, wheat, bran, vermiculite, and pasteurized soil) or dry powders. In some embodiments, the composition includes 10²-10¹² cfu per ml carrier, or 10⁴-10¹⁰ cfu per ml carrier, or 10⁶-10⁸ cfu per ml carrier. The composition may include additional additives including buffering agents, surfactants, adjuvants, or coating agents.

The disclosed compositions comprise one or more PGPR and one or more insecticides. Suitable insecticides for the disclosed compositions may include, but are not limited to neonicotinoids (e.g., acetamiprid, clothianidin, imidacloprid, nitenpyram, nithiazine, thiacloprid and thiamethoxam), phenypyrazoles (e.g., acetoprole, ethiprole, fipronil, flufiprole, pyraclofos, pyrafluprole, pyriprole, pyrolan, and vaniliprole), and pyrethroids (e.g., allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, metofluthrin, permethrin, resmethrin, silafluofen, sumithrin, tau-Fluvalinate, tefluthrin, tetramethrin, tralomethrin, and transfluthrin).

In some embodiments, the composition comprises the insecticide at a concentration of at least about 0.5%, 1%, 1.5%, 2%, 3%, 4%, 5%, 6%, 7%, 8%, 9%, 10%, 15%, 20%, 25%, and 30% and/or at a concentration of more than about 30%, 25%, 20%, 15%, 10%, 9%, 8%, 7%, 6%, 5%, 4%, 3%, 2%, 1.5%, 1%, and 0.5%, or within a concentration range bounded by any of these concentrations. Preferably, the composition comprises the insecticide at a lower effective concentration for controlling pests in the presence of the PGPR than the effective concentration for controlling pests in the absence of the PGPR. Suitable insecticides particularly may include imidacloprid.

Other components for use in the disclosed methods and compositions may include fertilizers. Fertilizers may be administered separately from the composition comprising the one or more PGPR and the one or more insecticides, or the fertilizer may be administered together with the composition comprising the one or more PGPR and the one or more insecticides (e.g., where the composition comprising the one or more PGPR and the one or more insecticides further comprises the fertilizer or where the fertilizer is present in a separate composition which is administered concurrently with the composition comprising the one or more PGPR and the one or more insecticides). Suitable fertilizers include nitrogen-containing fertilizers.

### ILLUSTRATIVE EMBODIMENTS

The following embodiments are illustrative and should not be interpreted to limit the claimed subject matter.

### Embodiment 1

A composition for promoting plant health and growth in a plant, the composition comprising and effective amount of: (i) one or more plant growth promoting-rhizobacteria (PGPR); and (ii) one or more insecticides; wherein the composition promotes health and growth when the composition is administered to a plant.

### Embodiment 2

The composition of embodiment 1, wherein the PGPR are selected from bacteria belonging to a genera selected from the group consisting of Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, and Lysinibacillus.

### Embodiment 3

The composition of embodiment 1 or 2, wherein the PGPR belong to the genus Bacillus.

### Embodiment 4

The composition of any of the foregoing embodiments, wherein the PGPR are selected from the group consisting of B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altitudinis, B. alveayuensis, B. amyloliquefaciens, B. anthracis, B. aquimaris, B. arsenicus, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyticus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. fastidiosus, B. firmus, B. flexus, B. foraminis, B. fordii, B. fortis, B. fumarioli, B. funiculus, B. galactosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. krulwichiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus, B. qingdaonensis, B. rigui, B. ruris, B. safensis, B. salarius, B. saliphilus, B. schlegelii, B. selenatarsenatis, B. selenitireducens, B. seohaeanensis, B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. thermoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and mixtures or blends thereof.

### Embodiment 5

The composition of any of the foregoing embodiments, wherein the composition comprises a mixture of PGPR.

### Embodiment 6

The composition of any of the foregoing embodiments, wherein the composition comprises the PGPR at a concentration of at least about 1×10⁵, 1×10⁶, 1×10⁷, 1×10⁸, 1×10⁹, 1×10¹⁰, 1×10¹¹, 1×10¹² colony forming units (CFU)/ml or within a concentration range bounded by any of these concentrations.

### Embodiment 7

The composition of any of the foregoing embodiments, wherein the insecticide comprises one or more neonicotinoids.

### Embodiment 8

The composition of any of the foregoing embodiments, wherein the insecticide comprises one or more neonicotinoids selected from the group consisting of acetamiprid, clothianidin, imidacloprid, nitenpyram, nithiazine, thiacloprid and thiamethoxam.

### Embodiment 9

The composition of any of the foregoing embodiments, wherein the insecticide comprises one or more neonicotinoids at a concentration of at least about 0.5%, 1%, 1.5%, 2%, 3%, 4%, 5%, 6%, 7%, 8%, 9%, 10%, 15%, 20%, 25%, and 30% and/or at a concentration of more than about 30%, 25%, 20%, 15%, 10%, 9%, 8%, 7%, 6%, 5%, 4%, 3%, 2%, 1.5%, 1%, and 0.5%, or within a concentration range bounded by any of these concentrations.

### Embodiment 10

The composition of any of the foregoing embodiments, wherein the insecticide comprises one or more phenypyrazoles.

### Embodiment 11

The composition of any of the foregoing embodiments, wherein the insecticide comprises one or more phenypyrazoles selected from the group consisting of acetoprole, ethiprole, fipronil, flufiprole, pyraclofos, pyrafluprole, pyriprole, pyrolan, and vaniliprole.

### Embodiment 12

The composition of any of the foregoing embodiments, wherein the insecticide comprises one or more phenypyrazoles at a concentration of at least about 0.5%, 1%, 1.5%, 2%, 3%, 4%, 5%, 6%, 7%, 8%, 9%, 10%, 15%, 20%, 25%, and 30% and/or at a concentration of more than about 30%, 25%, 20%, 15%, 10%, 9%, 8%, 7%, 6%, 5%, 4%, 3%, 2%, 1.5%, 1%, and 0.5%, or within a concentration range bounded by any of these concentrations.

### Embodiment 13

The composition of any of the foregoing embodiments, wherein insecticide comprises one or more pyrethroids.

### Embodiment 14

The composition of any of the foregoing embodiments, wherein insecticide comprises one or more pyrethroids selected from the group consisting of allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, metofluthrin, permethrin, resmethrin, silafluofen, sumithrin, tau-Fluvalinate, tefluthrin, tetramethrin, tralomethrin, and transfluthrin.

### Embodiment 15

The composition of any of the foregoing embodiments, wherein the insecticide comprises one or more pyrethroids at a concentration of at least about 0.5%, 1%, 1.5%, 2%, 3%, 4%, 5%, 6%, 7%, 8%, 9%, 10%, 15%, 20%, 25%, and 30% and/or at a concentration of more than about 30%, 25%, 20%, 15%, 10%, 9%, 8%, 7%, 6%, 5%, 4%, 3%, 2%, 1.5%, 1%, and 0.5%, or within a concentration range bounded by any of these concentrations.

### Embodiment 16

The composition of any of the foregoing embodiments further comprising a nitrogen-containing fertilizer.

### Embodiment 17

A method for increasing tolerance to stress in a plant in need thereof, the method comprising administering to the plant, to seeds of the plant, or to soil surrounding the plant, the composition of any of the foregoing embodiments comprising one or more PGPR and one or more insecticides.

### Embodiment 18

The method of embodiment 17, wherein the stress is damage from root-feeding pests, optionally wherein the root-feeding pests are selected from the group consisting of mole crickets and white grubs.

### Embodiment 19

The method of embodiment 18, wherein the root-feeding pests are Neoscapteriscus spp., optionally selected from the group consisting of Neoscapteriscus vicinus Scudder, Neoscapteriscus borellii Giglio-Tos, and Nesoscapteriscus abbreviates Scudder.

### Embodiment 20

The method of embodiment 18, wherein the root-feeding pests are grubs of species belonging to the Order Coleptera, Family Scarabaeidae, optionally wherein the pests are larvae of Popillia japonica (Japanese beetles).

### Embodiment 21

The method of embodiment 17, wherein the stress is drought.

### Embodiment 22

The method of any of embodiments 17-21, wherein the plant is a grass, optionally selected from bermudagrasses (Cynodon spp.), bahiagrass (Paspalum notatum Flugge), Saint Augustinegrass (Stenotaphrum secundatum (Walt) Kuntz), centipedegrass (Eremochloa ophiuroides (Munro) Hack), and zoysiagrass (Zoysia spp.).

### Embodiment 23

The method of any of embodiments 17-22, wherein the PGPR are selected from: (i) Bacillus pumilus or a bacteria having at least about 95%, 96%, 97%, 98%, or 99% nucleotide sequence identity to the 16S rRNA of Bacillus pumilus; (ii) Bacillus sphaericus or a bacteria having at least about 95%, 96%, 97%, 98%, or 99% nucleotide sequence identity to the 16S rRNA of Bacillus sphaericus; and (iii) a mixture of the bacteria of (i) and (ii).

### Embodiment 24

The method of any of embodiments 17-23, wherein the PGPR are Bacillus pumilus.

### Embodiment 25

The method of any of embodiments 17-24, wherein the PGPR are Bacillus sphaericus.

### Embodiment 26

The method of any of embodiments 17-25, wherein the PGPR are a mixture of Bacillus pumilus and Bacillus sphaericus.

### Embodiment 27

The method of any of embodiments 17-26 comprising administering the one or more PGPR to the soil surrounding the plant at a concentration of at least about 1×10⁵, 1×10⁶, 1×10⁷, 1×10⁸, 1×10⁹, 1×10¹⁰ colony forming units (CFU)/m², or within a concentration range bounded by any of these concentrations (e.g. 1×10⁶-1×10⁹ CFU/m²).

### Embodiment 28

The method of any of embodiments 17-27, wherein the composition is administered at least every day, every two days, every three days, every four days, every five days, every six days, every seven days (i.e., weekly), biweekly, monthly, or bimonthly.

### Embodiment 29

The method of embodiments 17-28, wherein the composition is administered at least on a weekly basis for at least two (2), three (3), four (4) weeks, five (5) weeks, six (6) weeks, seven (7) weeks, or eight (8) weeks.

### Embodiment 30

The method of any of embodiments 17-29, wherein the insecticide is selected from the group consisting of neonicotinoids (e.g., acetamiprid, clothianidin, imidacloprid, nitenpyram, nithiazine, thiacloprid and thiamethoxam), phenypyrazoles (e.g., acetoprole, ethiprole, fipronil, flufiprole, pyraclofos, pyrafluprole, pyriprole, pyrolan, and vaniliprole), and pyrethroids (e.g., allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, metofluthrin, permethrin, resmethrin, silafluofen, sumithrin, tau-Fluvalinate, tefluthrin, tetramethrin, tralomethrin, and transfluthrin).

### Embodiment 31

The method of any of embodiments 17-30, wherein the composition comprises the insecticide at a concentration of at least about 0.5%, 1%, 1.5%, 2%, 3%, 4%, 5%, 6%, 7%, 8%, 9%, 10%, 15%, 20%, 25%, and 30% and/or at a concentration of more than about 30%, 25%, 20%, 15%, 10%, 9%, 8%, 7%, 6%, 5%, 4%, 3%, 2%, 1.5%, 1%, and 0.5%, or within a concentration range bounded by any of these concentrations.

### Embodiment 32

The method of any of embodiments 17-31, wherein the insecticide is imidacloprid.

### Embodiment 33

The method of any of embodiments 17-32, further comprising administering a fertilizer to the plant, wherein the fertilizer is administered before the composition comprising the one or more PGPR and the one or more insecticides, currently with the composition comprising the one or more PGPR and the one or more insecticides (e.g., wherein the composition comprising the one or more PGPR and the one or more insecticides further comprises the fertilizer), or after the composition comprising the one or more PGPR and the one or more insecticides is administered.

### Embodiment 34

The method of any of embodiments 17-33, wherein the composition comprising the one or more PGPR and the one or more insecticides further comprises a nitrogen-containing fertilizer.

### EXAMPLES

The following Examples are illustrative and should not be interpreted to limit the scope of the claimed subject matter.

### Example 1—Bacterial Inoculant Treatment of Bermudagrass Alters Tolerance to Damage from Tawny Mole Crickets (Neoscapteriscus Vicinus Scudder)

Reference is made to Coy et al., “Bacterial inoculant treatment of bermudagrass alters tolerance to damage from tawny mole crickets (Neoscapteriscus vicinus Scudder),” Pest Manag Sci (2019), 13 Sep. 2019, pages 1-7; the content of which is incorporated herein by reference in its entirety).

Abstract

BACKGROUND: Inoculation of bermudagrass with rhizobacterial biostimulants can increase plant growth and influence relationships with above-ground herbivores. Tunneling and root-feeding behaviors of tawny mole crickets cause severe damage to grasses in pastures, golf courses, and lawns. Since bacterial inoculants enhance root growth, the goal of this study was to determine if inoculation of bermudagrass by root-colonizing bacteria (PGPR) can increase the tolerance of hybrid bermudagrass to tawny mole crickets, and if PGPR are compatible with current commonly used insecticides for mole cricket control.

RESULTS: In large arenas, bacteria-treated grass infested with mole crickets produced more shoot and root mass and 128-200% greater root lengths compared to fertilized, infested, and non-infested bermudagrass. Damaged field plots were treated and rated post-treatment. Damage ratings after 3 and 8 week were lowest in the bacteria-insecticide plots, with control having the highest damage. In this study, bacteria were compatible with neonicotinoid, phenylpyrazole, and pyrethroid insecticides when mixed for 2 weeks.

CONCLUSION: Bacterial mediated interactions increases tolerance of bermudagrass applied before, or in response to, damage. Application of PGPR to field plots reduced tunneling relative to control plots and provided comparable reductions to a short residual, synthetic pyrethroid insecticide. Rhizobacterial products have utility for IPM of root herbivores.

1. Introduction

There are growing concerns on the use of chemicals to sustain growth and productivity of plants facing challenges from abiotic and biotic stresses. These concerns are leading to the adoption of management tactics that take a system's based approach, emphasizing conservation and environmental stewardship while incorporating new technologies. Incorporation of biological technologies that are compatible with current management practices are avenues for development of new management strategies. Biologicals that enhance plant resistance or tolerance to abiotic and biotic stresses could minimize environmental consequences while reducing chemical and water input needs (1). Recently, Myresiotis et al. (2) demonstrated the increased root growth and uptake of a neonicotinoid (thiamethoxam) insecticide in corn seedlings in response to treatment with Bacillus subtilis. This increase in pesticide use efficiency could lead to lower use rates of systemic pesticides. Research into how grasses and microbes interact under stress conditions could lead to the development of biological products that enable continued productivity of high quality turf and pasture grasses under adverse conditions with limited resource input.

Turfgrasses in the United States cover 16.4 million hectares, an area larger than any other crop, encompassing diverse uses for residential, commercial, and recreational purposes (3, 4). Improvements in turfgrass cultivars for increased adaptability, aesthetic qualities, playability, as well as limited disease, and stress resistance have been the focus of traditional breeding programs. However, there are a limited number of successes related to grass-feeding insects and particularly root-feeding herbivores (3). Bacterial mediated interactions with plants that maintain productivity despite pest pressure may yield results easier and faster than traditional and molecular breeding programs. Rhizobacterial inoculants are used for the maintenance of high quality crops, including grasses (Poaceae) under normal and adverse conditions with limited resource input (5-8).

Mole crickets (Orthoptera: Gryllotalpidae, Neoscapteriscus) are solitary, subterranean insects that cause significant damage to turf, pasture, and other crops in sandy soils throughout the southeastern United States (9, 10). The fossorial forelegs of mole crickets aid in subterranean tunneling behavior, which results in direct damage of turfgrass from tunneling activities and root-feeding throughout the soil profile. The tunneling behavior not only damages grass roots, but displaces soil and disrupts playing surfaces (9, 11). There are three invasive species from the genus Neoscapteriscus occurring throughout the southeastern United States (3). The southern mole cricket (Neoscapteriscus borellii Giglio-Tos), the tawny mole cricket (N. vicinus Scudder), and the short-winged mole cricket (N. abbreviates Scudder), which has only been reported in Florida and Georgia. Damage severity caused by mole crickets can be species dependent. Typically, most damage is observed in tawny mole cricket infested areas as this species is herbivorous on grass roots and stems while having extensive, shallower tunnels; whereas N. borellii is carnivorous and produces deeper tunnels in the soil profile (12-14). Cultivar evaluations have focused on the susceptibility of bermudagrasses (Cynodon spp.), bahiagrass (Paspalum notatum Flugge), St. Augustinegrass (Stenotaphrum secundatum (Walt) Kuntz, centipedegrass (Eremochloa ophiuroides (Munro) Hack, and zoysiagrass (Zoysia spp.) to both the tawny and southern mole crickets, with work yet to identify any highly resistant cultivars to injury (13-15).

Primarily, interactions of PGPR with plants have focused on growth promotion and plant pathogens (16, 17), with more recent work on the influences of PGPR-plant interactions on insect folivores (18-23). Thus far, virtually no research has been conducted on soil-dwelling or root-feeding insects. This lack of research is probably due to the logistical challenges of direct observations of subterranean pests, but the plant-microbe-insect interactions may be more impactful for subterranean insects in close association and constant exposure to rhizobacteria. Using the tawny mole cricket-bermudagrass system, we determined if inoculation of bermudagrass by root-colonizing bacteria (PGPR) can increase plant tolerance to a below-ground insect herbivore and if PGPR are compatible with current commonly used insecticides for mole cricket control. Considering previous work, we expect that PGPR will be compatible with certain insecticides and alter the grasses response and increase tolerance to mole cricket tunneling and feeding behaviors.

2. Materials and Methods

2.1 Bacterial Strains and Inoculant Preparation

One PGPR blend (Blend 20) consisting of 3 bacterial strains (Bacillus pumilus AP 7, Bacillus pumilus AP 18, and Bacillus sphaericus AP 282) reported to induce growth promotion in bermudagrass and deter fall armyworm (Spodoptera frugiperda J.E. Smith) oviposition (6, 18) was tested. Bacterial strains stored at −80° C. were transferred from cryovials to plates of tryptic soy agar (TSA) and allowed to grow at 28° C. in an incubator. After 24-48 h, bacterial lawns were scraped from TSA plates with inoculating loops and transferred to either new TSA plates or to sterile centrifuge tubes (50 ml, VWR, Radnor, Pa.) containing 40 ml of sterile water, and vigorously shaken to evenly distribute bacterial cells. Serial 10-fold dilutions were then made of each bacterial suspension into sterile water blanks to a final dilution of 10⁻⁵.

Bacterial populations (number of colony forming units [CFU]) in the suspensions were determined by plating 50 μl of the serial dilution onto TSA plates, incubating plates for 24-48 h and then counting the number of bacterial colonies on each plate. Once the concentrations (CFU per ml) in the prepared suspensions of each strain were determined, these populations were used to make bacterial stock solutions for each strain. Stock solution of the bacterial blend was prepared by the addition of one liter of equal parts of each bacterium to achieve a blend with a final concentration of 1×10⁷ CFU per ml of each strain.

2.2 Bacterial Strains and Insecticide Compatibility

The strains of Blend 20, each with a minimum concentration of 1×10⁸ CFU per ml were individually evaluated for their compatibility with commonly used liquid insecticides. The strains were evaluated individually to make recovery of each bacterium apparent, as the colony morphologies are similar. Freshly prepared bacteria stock solutions were evaluated for their ability to survive being ‘tank’ mixed with insecticides in 50 ml centrifuge tubes with three different insecticides mixed together for 1 h, 24 h, and 1 wk, and 2 wk at 25 s ° C. under ambient light. The bacteria were evaluated for compatibility with insecticides which included three chemical groups: neonicotinoids, phenylpyrazoles, and pyrethroids. The pesticides evaluated were bifenthrin (Talstar Pro, FMC Corporation, Philadelphia, Pa.), fipronil (Termidor SC, BASF Corporation, Florham Park, N.J.), imidacloprid (Merit 2F, Bayer, Research Triangle Park, N.C.). While Termidor SC is not used on golf courses, it was selected for convenience because the active ingredient (Fipronil) is formulated as a granular product and widely used for mole cricket management (24). Bacteria and pesticide solutions were prepared based on the label recommendations for volume of area covered (bifenthrin, imidacloprid) or amount of active ingredient per volume needed (fipronil). Bifenthrin and fipronil were evaluated at high and low label rates. Bifenthrin was mixed at a rate of 29.6 and 14.8 ml per 92.9 m² (7.9% active ingredient, 302 g per 3,785 ml). Imidacloprid was mixed a rate of 17 ml per 92.9 m² (21.4%, 907 g per 3,785 ml). Fipronil was prepared at 47.3 (0.125% dilution) and 23.65 ml (0.06% dilution) per 3,785 ml (9.1% active ingredient, 363 g per 3,785 ml). After the allotted time, the centrifuge tubes were vigorously shaken to evenly distribute bacterial cells before serial 10-fold dilutions. Serial dilutions were made of each bacterial suspension into sterile water blanks to a final dilution of 10⁻⁵. Bacterial populations (number of colony forming units [CFU]) in the suspensions were determined by plating 50 μl of the 10⁻⁵ serial dilutions onto three TSA plates, incubating plates for 24 h and then counting the number of bacterial colonies on each plate.

2.3 Sources of Insects and Preparation

Tawny mole crickets (Neoscapteriscus vicinus Scudder) were locally obtained from soapy water flushing over infested areas on golf course greens and tee boxes (25). After emerging from the soap flush in the field, mole crickets were rinsed free of soap and placed in deep Petri dishes (100 mm×25 mm, VWR, Radnor, Pa.) filled with moist sand and provided freeze-dried mealworms (Coleoptera: Tenebrionidae; Fluker Farms, Port Allen, La.) and organic carrots as food sources. Soil moisture and food sources were replaced as needed. Until they were needed, mole crickets were maintained in a growth chamber at 26.7° C.

2.4 Arena Experiment

Two trials were conducted outdoors in the summer (Trial 1) and fall (Trial 2) of 2016. Treatments included one PGPR blend (Blend 20) with mole crickets, a fertilized control with mole crickets, a non-treated control with mole crickets, and a non-treated control without mole crickets. Each treatment was replicated four times per trial in a randomized complete block design using large PVC arenas similar to Bailey et al. (9). For these trials, plugs of Tifway hybrid bermudagrass (3.8 cm diameter) were harvested from the Auburn University Turfgrass Research Unit, Auburn, Ala. After harvesting, plugs were washed free of field soil and transplanted into clean, fine sand. In the first trial, 10 hybrid bermudagrass plugs were planted and established in arenas (PVC cylinders, 25.4 cm diameter×45.2 cm high). Arenas were held above ground outdoors on a landscape fabric mat under overhead irrigation for the duration of the experiment. After transplanting in Trial 1, grasses received 1.45 g/(14.5 kg/ha weekly, 58 kg/ha monthly) granular ammonium sulfate fertilizer (PRO fertilizer, 21-0-0; Harrell's Inc., Lakewood, Fla.) weekly followed by 675 ml (1.27 cm) of water after fertilizer was applied. All arenas were fertilized and plants cut weekly to a height of 3.7 cm for 4 wk until treatments were applied. For Trial 2, individual grass plugs were grown in a plastic pot (7.6 cm diameter×20.3 cm high; MT38 Mini-Treepot, Stuewe and Sons, Tangent, Oreg.) for 4 wk before 10 plugs were transplanted into each PVC cylinder. While growing in the plastic pots, grasses received 1.45 g/m² granular ammonium sulfate fertilizer weekly followed by 75 ml (1.27 cm) of water after fertilizer was applied. During this time, grasses were cut weekly to a height of 3.7 cm. Treatments were applied after transplanting in Trial 2. Except when applications were made, pots were watered as needed.

Arenas were randomly assigned to each treatment and the following treatment methods were used in both trials. Those assigned to the bacteria treatment received weekly inoculations of 26.5 ml (500 ml/m²) of a freshly-prepared aqueous bacterial suspension of 1×10⁷ CFU per ml applied to the growing media of each pot followed by 675 ml of water for 6 wk. The same volume of distilled water was applied to the control plants each time bacteria were applied. Pots assigned to the fertilizer treatments received 1.45 g/m² granular ammonium sulfate fertilizer weekly and 675 ml water after fertilizer was applied. After two applications of each treatment, tawny mole crickets were placed into each of the infested treatments (PGPR, fertilizer, and control). Mole crickets were placed on the surface and allowed to burrow into the soil. Each of these arenas was infested with six mole crickets in Trial 1 and five mole crickets in Trial 2. The non-infested controls were free of insects to determine grass productivity in the absence of herbivory.

Weekly top growth beyond 3.7 cm was cut, collected, and weighed. Fresh weights of grass clippings were recorded before samples were oven dried at 70° C. for 72 h and weighed again for dry weight (6). A week after the sixth application of each treatment, the arenas were destructively sampled and the mole crickets were collected, counted, and weighed. The root system of each arena was collected and washed in the lab. After washing, root fresh weights were recorded before digital image analysis of the linear root structure was conducted using a root scanning system (Regent Instruments, Inc. Sainte-Foy, Quebec) which consisted of a scanner (LA 1600+) and WinRhizo software (2004a). Based on image analysis, the software calculated total root length. After scanning the root systems, the roots were dried in an oven at 70° C. for 72 h. The data collected were used to compare root growth and top growth to determine if Blend 20 caused growth promotion in bermudagrass relative to the infested fertilized, infested non-treated, and uninfested non-treated plants.

2.5 Field Plots

On 26 Mar. 2017 field plots were established at the Auburn University Turfgrass Research Unit, Auburn, Ala. over hybrid and common bermudagrass tawny mole cricket infested areas in a Marvyn loamy sand. Plots were 3 m×2 m with at least 2 m separating plots. Field plots were assessed for mole cricket damage based on the rating system of Cobb and Mack (26). A 1 m×1 m frame divided into a grid with 9 subsections was used to score the plots on a scale of 0-9, where 0 indicates no damage and 9 indicates activity in each section. After the initial assessment, plots were assigned to a treatment group based on damage ratings. Damage ratings were completed nine times on Day 0, 14, 21, 28, 33, 42, 46, 52, and 56. Damage assessments were taken from seven locations (center, top left, top right, bottom left, bottom right, middle left, and middle right), with one location sampled during each damage assessment period for all treatments. The experiment evaluated four treatments, PGPR-treated (Blend 20), bifenthrin-treated, PGPR+bifenthrin-treated, and non-treated control. On 27 Mar. 2017 (Day 0) and 23 April (Day 27) plots were treated with a backpack sprayer. Bacteria-treated plots received 3 L (500 ml/m²) freshly-prepared aqueous bacterial suspension of 1×10⁷ CFU per ml. Bifenthrin-treated plots were treated at a rate of 29.6 ml per 92.9 m². The sprayer applied 244 ml of this mixture per plot. PGPR+ bifenthrin plots were treated with the 3 L of bacteria and 244 ml of bifenthrin mixed together in the same tank. The non-treated plots were treated with 3 L of distilled water coincident with treatment of the other plots. After treating, the plots were hand watered with 76.2 L of water (1.27 cm) to move the treatments into the root zone. The experiment was replicated six times for each treatment.

2.6 Statistical Analysis

Top growth (fresh and dry mass) in the cylinder trials were analyzed separately using repeated measures of multivariate analysis of covariance (MANCOVA) due to trial being a significant factor (P<0.05, JMP Version 13. SAS Institute Inc., Cary, N.C., 1989-2007). Root fresh and dry mass, and length were analyzed using orthogonal contrasts (P<0.05, JMP Version 13. SAS Institute Inc., Cary, N.C., 1989-2007). The number of mole crickets recovered and mole cricket weights from each treatment were used as covariants. Mole cricket weights were analyzed using analysis of variance (ANOVA), Student's t-test. The number of mole crickets recovered and mole cricket weights within treatments were not significant in either PVC arena trial. For the field trial, LSMeans, Student's t-Test (LSD, P<0.05) was used to compare each sampling period's mole cricket damage ratings.

3. Results

3.1 Bacteria and Insecticide Compatibility

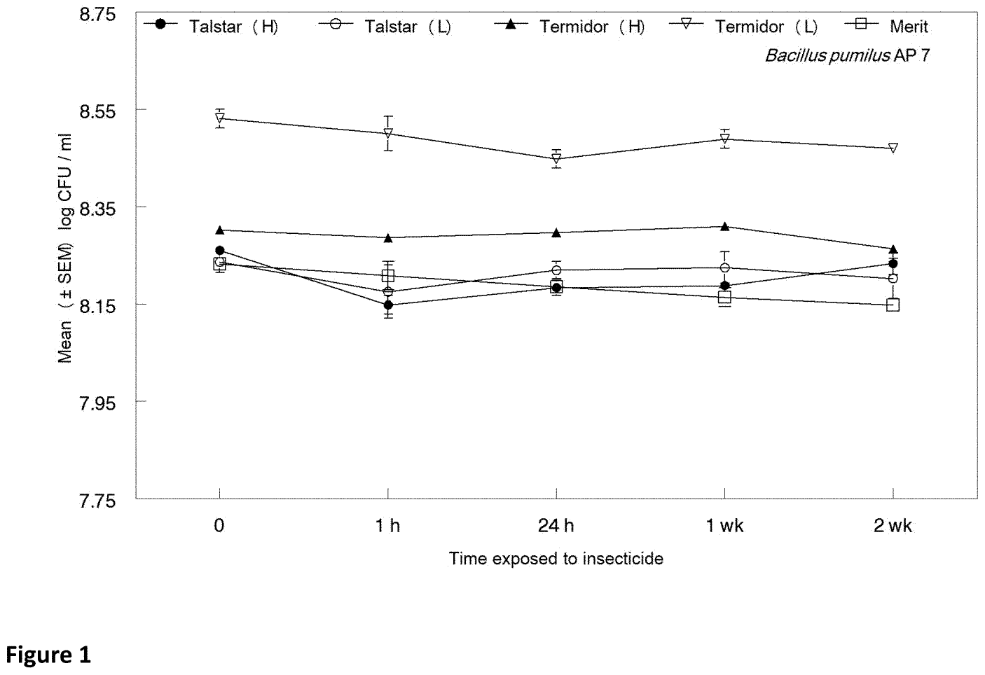

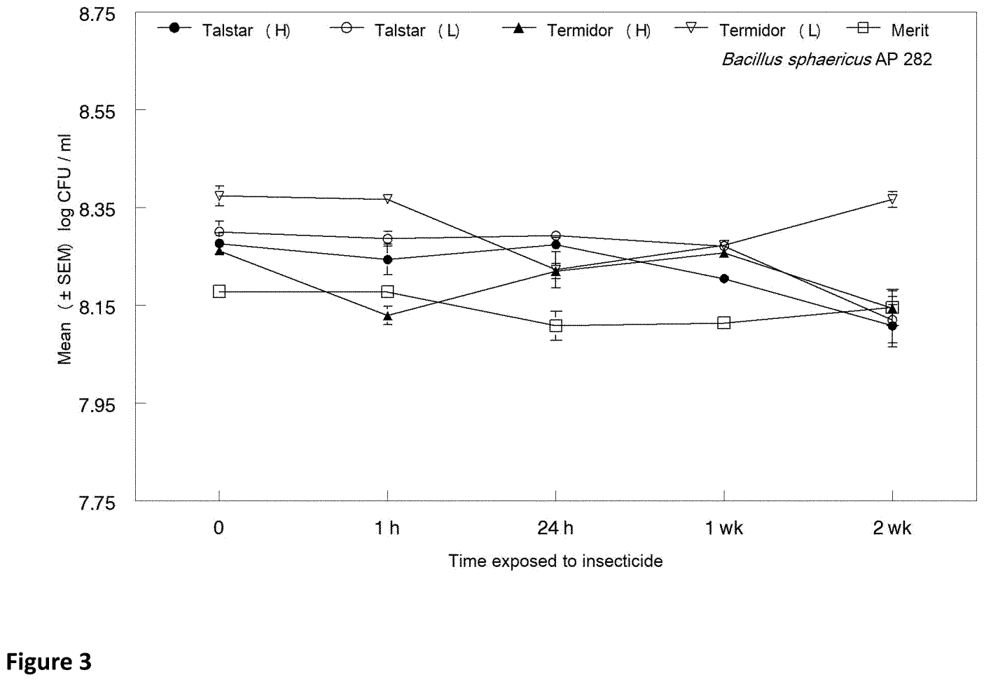

In this trial, all strains of Blend 20 (Bacillus pumilus AP 7, Bacillus pumilus AP 18, and Bacillus sphaericus AP 282) were mixed with insecticides commonly used to control mole crickets. All strains were not negatively impacted, and remained stable when mixed with a neonicotinoid (Imidacloprid), phenylpyrazole (Fipronil), and pyrethroid (Bifenthrin) insecticide for 2 wk (FIGS. 1-3). Slight variations in populations are likely a result from bacterial distribution in the centrifuge tubes, serial dilutions, and growth times of bacteria on colonies. All populations remained within the standard errors of the initial populations.

3.2 Arena Experiment

These experiments evaluated if PGPR application before mole cricket infestation and repeated applications after infestation would increase the tolerance of bermudagrass to tawny mole crickets. Recovery of live mole crickets in the first trial was 55.5% and 60% in the second trial, with no replicates having less than 40% recovery. Final weights of mole crickets increased relative to initial weight in both trials. In Trial 1, final weights ranged from 550-596 mg and from 852-873 in Trial 2. There was no difference between treatments in mole cricket weights in either Trial (Trial 1, F=0.35, df=39, P=0.709; Trial 2, F=0.05 df=35, P=0.947).

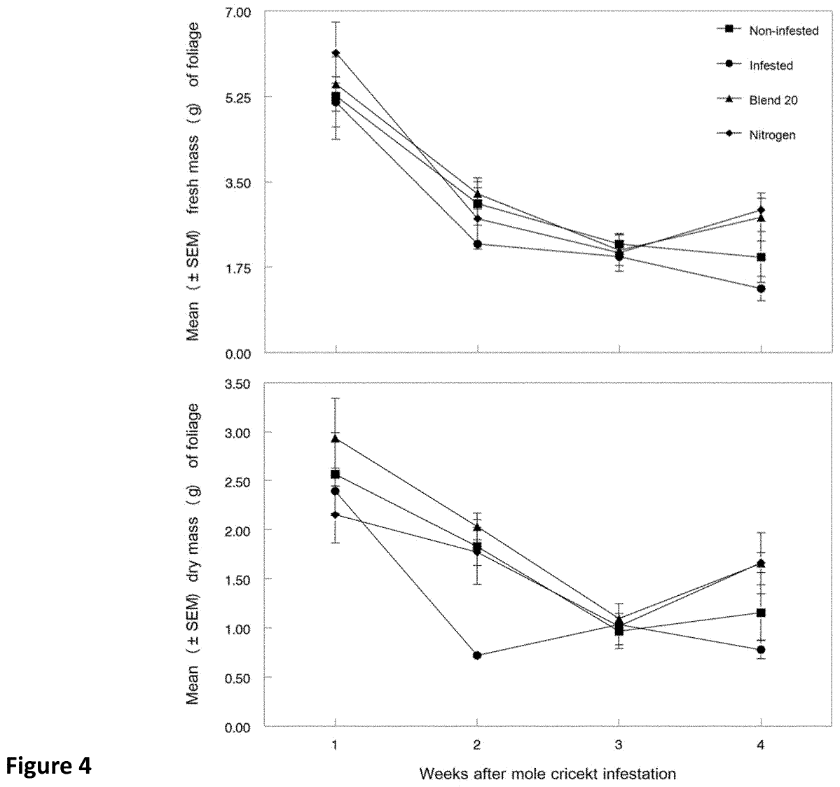

Plant growth response parameters in the PVC arenas in Trial 2 were greater than in Trial 1, resulting in a significant trial effect (F=10.48, df=1, 26, P=0.003). In Trial 1, fresh and dry mass of foliage were not significant across treatments (fresh mass, F=0.52, df=3, 11, P=0.675; dry mass, F=0.48, df=3, 11, P=0.703). In Trial 2, the infested control arenas produced the lowest shoot mass (FIG. 4). The arenas treated with Blend 20 or fertilizer, and the non-infested control arenas had significantly greater shoot mass than the infested controls (F=13.90, df=3, 11, P<0.001). Bermudagrass treated with Blend 20 or nitrogen-fertilized produced similar amounts of top growth (fresh mass, F=0.18, df=3, 11, P=0.68; dry mass, F=0.07, df=3, 11, P=0.8). Both Blend 20 and nitrogen treatments produced significantly more fresh shoot mass than the non-infested controls (PGPR fresh mass, F=15.62, P=0.002; Nitrogen fresh mass, F=16.32, P=0.002), but only PGPR produced significantly more dry mass than the infested control (dry mass, F=15.3 P=0.002).

Root length, fresh and dry mass were analyzed separately by trial, infesting bermudagrass with mole crickets reduced total root length on average by 203 cm (P=0.053, df=1, orthogonal contrasts) and 101 cm (P=0.643, df=1) for Trials 1 and 2, respectively. PGPR-treated bermudagrass produced the greatest root fresh mass and length in both trials and the greatest dry mass in Trial 2 (Tables 1-2). In Trial 1, PGPR-treated bermudagrass infested with tawny mole crickets produced nearly 300 cm more in total root length than bermudagrass held under similar conditions without mole crickets (orthogonal contrast, P≤0.078, df=1). Relative to treatments infested with mole crickets, PGPR-treated bermudagrass produced >500 cm of total root length more than bermudagrass treated with either nitrogen or non-treated controls (Trial 1, orthogonal contrast, P=0.001, df=1). Because growth was greater in Trial 2, the magnitude of the treatment differences was greater. Bermudagrass treated with PGPR and infested with tawny mole crickets produced >180% more in total root length relative to bermudagrass held under similar conditions with or without mole crickets (orthogonal contrast, P<0.001, df=1). PGPR-treated bermudagrass infested with mole crickets also produced more total root length than bermudagrass treated with nitrogen (Trial 2, orthogonal contrast, P=0.002, df=1). Root dry mass was not significantly different for any treatment comparison in Trial 1 (Table 1, means; Table 2, orthogonal contrasts, P>0.05).

TABLE 1
Root mass and total root length of Tifway bermudagrass after
treatment for 5 weeks with tawny mole cricket infested
treatment or in control bermudagrass without mole crickets

| | Treat- | | | |
|---|---|---|---|---|
| Trial | ment^{a} | FW^{b} (g) | DW^{b} (g) | Length (cm)^{c} |
| 1 | no mole | 37.12 ± 1.20 | 5.91 ± 0.22 | 1,217.16 ± 168.45 |
| | crickets | | | |
| 1 | with mole | 37.49 ± 9.16 | 5.76 ± 1.27 | 1,019.96 ± 199.78 |
| | crickets | | | |
| 1 | Nitrogen^{d} | 41.12 ± 6.83 | 6.67 ± 1.04 | 1,036.02 ± 182.82 |
| 1 | Blend 20^{e} | 53.06 ± 4.32 | 6.57 ± 0.11 | 1,557.89 ± 77.20 |
| 2 | no mole | 100.98 ± 4.35 | 18.34 ± 0.93 | 1,679.20 ± 122.33 |
| | crickets | | | |
| 2 | with mole | 73.30 ± 6.96 | 12.24 ± 0.74 | 1,578.45 ± 150.93 |
| | crickets | | | |
| 2 | Nitrogen | 103.44 ± 17.64 | 19.58 ± 4.23 | 2,284.23 ± 319.97 |
| 2 | Blend 20 | 111.06 ± 4.24 | 21.56 ± 1.28 | 3,154.85 ± 143.04 |

^{a}Treatments were applied weekly for 6 weeks, beginning 2 weeks before mole crickets with four applications while infested. Non-infested received no treatment and no mole crickets.
^{b}Sampled one week after last application. Root mass as fresh weight (FW) or dry weight (DW).
^{c}Sampled one week after last application. Total root length (cm) determined by digital image analysis using WinRhizo software.
^{d}Ammonium sulfate at a rate of 5.81 g/m² and infested with mole crickets.
^{e}Blend 20 (Bacillus pumilus AP 7, Bacillus pumilus AP 18, Bacillus sphaericus AP 282) applied at a rate of 500 mL/m² and infested with mole crickets.

In Trial 2, root dry masses were significantly greater for bermudagrass infested with mole crickets treated with either nitrogen or PGPR (Table 2, P≤0.015) compared to bermudagrass infested with no treatment. PGPR and nitrogen produced roots with similar dry masses in Trials 1 and 2.

TABLE 2
Orthogonal contrasts comparing Tifway bermudagrass roots of
bacteria-treated, and fertilized after 5 weeks with or without
tawny mole crickets

| | | | | | | Length | |
|---|---|---|---|---|---|---|---|
| Trial | Contrast^{a} | FW (g) | | DW (g) | | (cm) | |
| 1 | Blend 20^{b} vs no | P = | 0.062 | P = | 0.459 | P = | 0.077 |
| | mole crickets^{c} | | | | | | |
| 1 | Blend 20 vs with | P = | 0.071 | P = | 0.450 | P = | 0.001* |
| | mole crickets^{d} | | | | | | |
| 1 | Blend 20 vs | P = | 0.087 | P = | 0.675 | P = | 0.001* |
| | Nitrogen^{e} | | | | | | |
| 1 | No mole crickets | P = | 0.950 | P = | 0.987 | P = | 0.053 |
| | vs with mole | | | | | | |
| | crickets | | | | | | |
| 1 | Nitrogen vs no | P = | 0.745 | P = | 0.733 | P = | 0.069 |
| | mole crickets | | | | | | |
| 1 | Nitrogen vs with | P = | 0.915 | P = | 0.745 | P = | 0.886 |
| | mole crickets | | | | | | |
| 2 | Blend 20 vs No | P = | 0.442 | P = | 0.278 | P = | P < 0.001* |
| | mole crickets | | | | | | |
| 2 | Blend 20 vs with | P = | 0.009* | P = | 0.006* | P = | P < 0.001* |
| | mole crickets | | | | | | |
| 2 | Blend 20 vs | P = | 0.582 | P = | 0.652 | P = | 0.002* |
| | Nitrogen | | | | | | |
| 2 | No mole crickets | P = | 0.043* | P = | 0.055 | P = | 0.643 |
| | vs with mole | | | | | | |
| | crickets | | | | | | |
| 2 | Nitrogen vs no | P = | 0.824 | P = | 0.517 | P = | 0.022* |
| | mole crickets | | | | | | |
| 2 | Nitrogen vs with | P = | 0.028* | P = | 0.015* | P = | 0.009* |
| | mole crickets | | | | | | |

*denotes significance between treatments from orthogonal contrasts (P < 0.05, df = 1; JMP Version 13. SAS Institute Inc., Cary, NC, 1989-2007).
^{a}Refers to all arenas within a treatment.
^{b}Blend 20 (Bacillus pumilus AP 7, Bacillus pumilus AP 18, Bacillus sphaericus AP 282) applied weekly at a rate of 500 mL/m² and infested.
^{c}Bermudagrass not treated with either PGPR or fertilizer treatment and without mole crickets.
^{d}Bermudagrass not treated with either PGPR or fertilizer treatment, but infested with mole crickets.
^{e}Ammonium sulfate applied weekly at a rate of 5.81 g/m² and infested.

For root fresh mass, PGPR-treatment of bermudagrass was not different from any other treatment at P<0.05 in Trial 1. However, at P<0.1, PGPR-treated fresh masses were greater than all treatments. Differences in root fresh mass were observed in Trial 2, with PGPR-treated grass having the greatest root mass of all treatments. Root fresh weights of bermudagrass treated with either PGPR or nitrogen and infested with mole crickets, and non-infested bermudagrasses were similar, and all were significantly greater than the infested control (P≤0.043).

3.3 Field Plots

Tunneling activity of mole crickets is dependent on soil moisture (27). During the study, rain events occurred on 17 days during the study resulting in 23.69 cm of total precipitation. Significant rain events occurred on April 28 (4.52 cm, Day 32), May 1 (3.43 cm, Day 35), May 5 (1.32 cm, Day 39), May 13 (1.19 cm, Day 47), and May 21 (1.68 cm, Day 55). The average soil temperature at a 10.2 cm depth was 17.99° C. (ranged from 14.44-21.67° C.). Soil moisture appeared adequate to maintain damage ratings ≥7 (out of 9) in non-treated control plots through 21 d. Following the second application on day 27, damage ratings in control plot were generally lower.

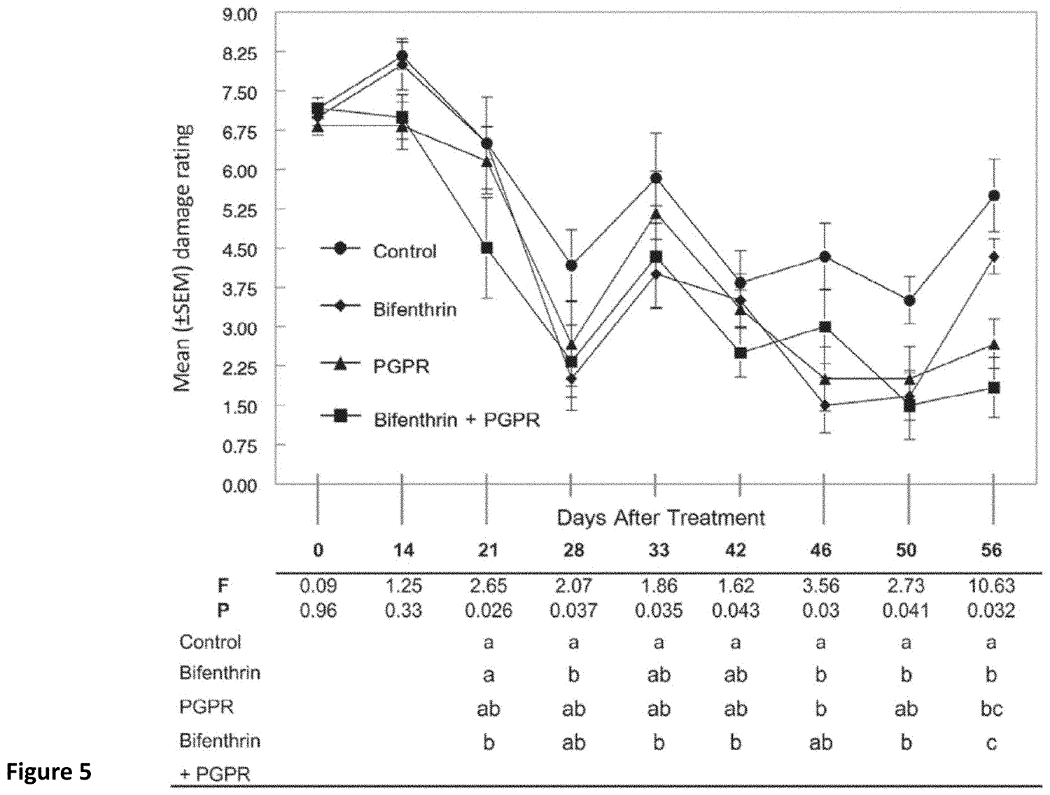

All field plots had similar damage ratings at the beginning of the experiment (Days 0 and 14; P>0.05; Table 3, FIG. 5) and untreated plots had the highest damage ratings throughout the study. The damage ratings of PGPR-only and bifenthrin-only treated plots were never significantly different from one another (P≥0.13, df=3). Beginning at 21 DAT, one or more treatments had significantly lower damage ratings than control plots (P<0.05; Table 3, FIG. 5). Among treated plots, the combined PGPR and bifenthrin treatment had the lowest damage ratings except for the first sample following re-application (28 DAT). Damage to plots treated with PGPR mixed with bifenthrin were never significantly different from plots where only PGPR was applied. Plots treated with PGPR mixed with bifenthrin had significantly less damage then bifenthrin-only treated plots at 21 and 56 DAT (P≤0.03, df=3). These two treatments had similar damage ratings on all other sample dates.

TABLE 3
Tawny mole cricket curative field study (2017) evaluating insecticide and bacteria
Mean Mole Cricket Damage Ratings, Days After Treatment (Days After Re-Treatment)

| | | | | 28 | 33 | 42 | 46 | 50 | 56 |
|---|---|---|---|---|---|---|---|---|---|
| Treatment | 0 | 14 | 21 | (1) | (5) | (15) | (19) | (23) | (29) |
| Untreated | 7.71a | 8.47a | 7.29a | 4.10a | 7.24a | 4.62a | 4.86a | 3.67a | 6.48a |
| Bifenthrin | 7.52a | 7.95a | 7.14a | 1.71b | 5.10ab | 3.90ab | 1.48b | 1.86b | 4.43b |
| PGPR | 7.52a | 7.57a | 6.71ab | 3.38ab | 5.67ab | 3.71ab | 2.24b | 2.29ab | 3.00bc |
| Bifenthrin + | 7.81a | 7.33a | 4.05b | 2.24ab | 4.14b | 2.52b | 3.62ab | 1.43b | 1.71c |
| PGPR | | | | | | | | | |
| Statistics | F = 0.09, | F = 1.25, | F = 2.65, | F = 2.07, | F = 1.86, | F = 1.62, | F = 3.56, | F = 2.73, | F = 10.63, |
| | P = 0.966 | P = 0.330 | P = 0.026 | P = 0.037 | P = 0.035 | P = 0.043 | P = 0.030 | P = 0.041 | P = 0.032 |

Mole cricket damage rating ranged from 0-9, 0 = no damage, 9 = severe damage.
Means followed by the same letter are not significantly different (LSMeans Student's t-test, P < 0.05, df = 4, 3; JMP Version 13. SAS Institute Inc., Cary, NC, 1989-2007).

4. Discussion

The effects of PGPR inoculation of grasses have focused mainly on growth promotion (6, 28), nematode suppression or mitigation (29), and other work from our lab with insect folivores (18). In bermudagrass, Coy et al. (18) noted certain PGPR strains and blends may selectively promote root growth and those may be better suited to evaluate changes in plant tolerances to root-feeders. The purpose of this study was to determine if inoculation of bermudagrass by root-colonizing bacteria (PGPR) can increase plant tolerance to a below-ground insect herbivore and if PGPR are compatible with current commonly used insecticides for mole cricket control. We used the tawny mole cricket as the model insect herbivore because it is a significant pest of turf and pasture grasses. We hypothesized that PGPR inoculation of bermudagrass would increase the plants tolerance to mole cricket activity and would remain stable when tank mixed with certain insecticides. Based on our literature review, this study represents the first to investigate PGPR inoculation and show positive effects on plants infested with a below-ground insect herbivore.

Foliage growth of bermudagrass treated with either PGPR or nitrogen was sustained or enhanced even when infested with mole crickets. Grass productivity (root and top growth) was lower in general in Trial 1 of the arena experiment, so differences in mass of grass foliage produced were only evident in Trial 2. The differences in trials between growth responses could be attributed to growth responses due to timing of the year or grass establishment methods, but the trends of increased root and top growth with PGPR are consistently observed (6). In Trial 2 of the arena experiment, grasses treated with nitrogen or PGPR and infested with mole crickets continued to produce more top growth than either infested or non-infested grass. When applied before mole crickets are present, growth promotion with fertilizer or PGPR appear to mitigate the negative effects on top growth over 4 wk when bermudagrass is infested with mole crickets. Relative to top growth, nitrogen and PGPR application produced similar results in Trial 2. In related work in our lab, the PGPR in Blend 20 are reported to promote significant top growth and increase and change root architecture in hybrid bermudagrass (6). Blend 20 was selected for this study based on the growth promotion in bermudagrass which is not always evident with other strains or blends of PGPR. Blend 20 can increase root and shoot mass in grass but not significantly more biomass production compared with synthetic fertilizers (30). Fike (30) compared seasonal production of foliar biomass of Coastal bermudagrass, a pasture grass, treated with either Blend 20 or a full (56 kg/ha) or half rate (28 kg/ha) of ammonium sulfate. In that study, both rates of synthetic fertilizer outperformed Blend 20. While foliar biomass is desired in certain situations (e.g., pastures), the top growth produced by Blend 20 was still comparable to nitrogen under the biotic stress imposed by the feeding and tunneling of mole crickets. Furthermore, excessive foliar growth in a low cut turfgrass situation is not desirable.

The arena experiment also showed similar results for root growth. Plants in Trial 1 produced smaller roots and differences in root mass were not detected. In Trial 2, root growth mirrored top growth. Nitrogen and PGPR-treated grass infested with mole crickets produced similar root mass to one other and greater root mass than infested, non-treated grass. Of these two treatments, however only grasses treated with Blend 20 and subject to mole crickets produced greater root fresh mass than non-infested grass. Treatment differences were more obvious with total root length. PGPR-treatment of bermudagrass outperformed root lengths relative to nitrogen fertilized grass by 501-870 cm. Bermudagrass inoculated with PGPR produced 200-1475 cm more of root length than non-infested, and 543-1576 cm more than non-treated bermudagrass infested with mole crickets. The PGPR in Blend 20 is also know to increase and change root architecture in hybrid bermudagrass (6). Blend 20 was selected for this study based on the growth promotion in bermudagrass which is not always evident with other strains or blends of PGPR. A review of microbe-plant-insect interactions, Pineda et al. (31) suggested that the effects of microbes on plants may be strengthened under biotic or abiotic stress. The mechanisms are not well understood but microbes are likely acting in ways to stimulate biosynthetic pathways related to stress (32). This may explain the greater total root length produced in bermudagrass inoculated with PGPR and subjected to tawny mole crickets compared to grass that was not infested or treated with nitrogen.

The use of bacterial biostimulants may result in increases root biomass and length when applied before pest problems exist but the field experiment evaluated PGPR applied to an active infestation. Mole crickets (Neoscapteriscus spp.) typically alter turfgrass playability and aesthetic qualities from surface tunneling activities, root-feeding, and soil displacement (27). Mitigation of surface tunneling and root disruption are the primary goals of mole cricket management. The field experiment showed that application of PGPR alone can lead to reductions in tunneling relative to control plots and comparable reductions to an application of a short residual, synthetic pyrethroid insecticide (Table 3). Furthermore, we hypothesized that a mixture of PGPR and the same insecticide would reduce tunneling and hasten the recovery of the infested grass. In two samples (21 and 56 DAT), plots treated with PGPR plus bifenthrin had significantly lower damage ratings than bifenthrin alone. These two samples were about 3-4 wk respectively after the application to the plots but no differences within the first 2 wk post application. There are a few possibilities to explain this. First, all plots were under heavy pressure for the first 3 wk of the experiment which likely reduced root mass (not measured). Where roots were limited, PGPR may not have been able to rapidly colonize. In this and past work, we have used an inoculation strategy to introduce PGPR to bermudagrass. This typically involves applying a population density of 1×10⁷ CFU per ml, which is lower than most commercial products (minimum, 1×10⁹ CFU per ml). Bacterial colonization of plants is speculated to occur between 10⁶⁻⁸ bacterial cells per cm² (33). PGPR inoculation into field soil would also create the potential for competition for sites along roots with existing soil bacteria (17).

These field experiment suggests that incorporation of bacterial or biological biostimulants into turfgrass may require more frequent or ‘booster’ applications to establish PGPR or augment populations. While research gaps remain as to the best formulation, application frequency, and population density for colonization and plant benefits within amenity or agronomic crops, especially perennial plants, ongoing research in our lab is investigating colonization. The two applications of bacteria, insecticide, or a bacteria-insecticide combination were separated by 4 wk intervals, but a shorter time frame (2 wk) may be better suited for quick control and growth responses with a short residual, pyrethroid insecticide. It is unlikely that PGPR-alone would provide comparable control and responses like phenylpyrazole (fipronil) or neonicotinoid (clothianidin, imidacloprid, thiamethoxam) insecticides, but may be positively correlated with increases in efficiency, uptake, and use rates of systemic insecticides (2).

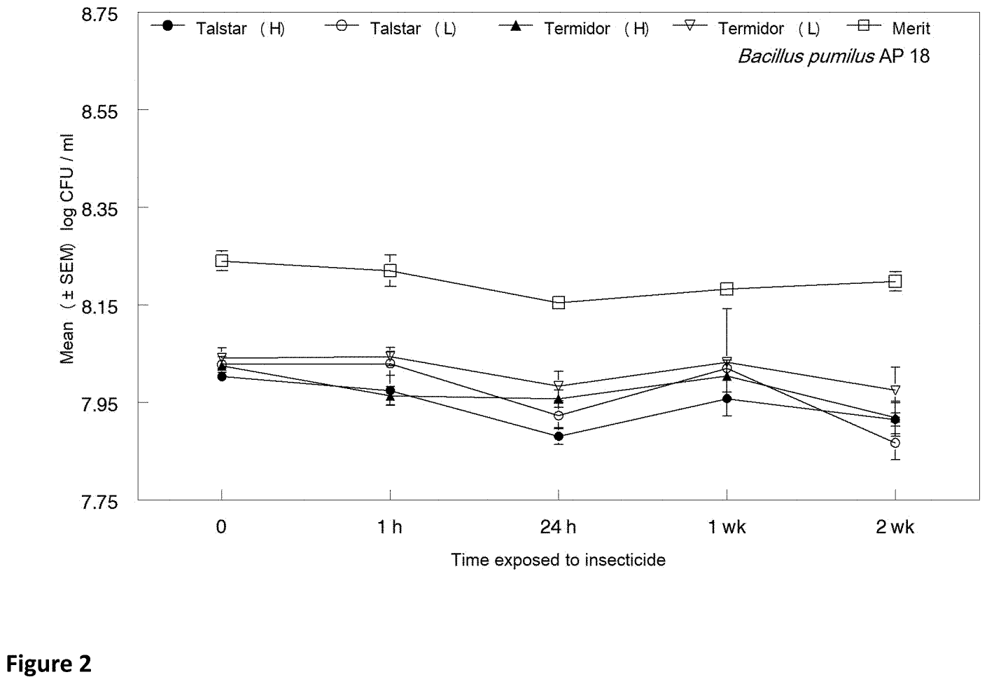

The population of Bacillus spp. in Blend 20 are compatible and stable when mixed with liquid formulations of neonicotinoid, phenylpyrazole, or pyrethroid insecticides commonly used for control of mole crickets (FIGS. 2-4). This is not surprising, given previous bacterial work with Bacillus subtilus which has confirmed endophytic plant colonization by the bacterium, and the increased pesticide uptake and plant growth with the use of thiamethoxam (2, 34). Additionally, bacteria have positive relationship with fertilizers and may increase efficiency of fertilizer use, which may allow for lower use rates of many agrochemicals (35). Although PGPR appear to not be impacted by these insecticide formulations, we suspect PGPR to not be compatible with all pesticides, extracts, or formulations. Populations of Pseudomonas fluorescens remained stable when mixed with the insecticides avermectin, carbofuran, chlorpyriphos, and endosulfan, but not with indoxacarb (36-38). P. fluorescens populations when mixed with the fungicides carbendazim and thiram, or certain plant extracts like, neem seed kernel extract (NSKE) (36) were not negatively impacted; however, populations were negatively impacted by cotton seed treatments with imidacloprid (37) or when mixed with the fungicides mancozeb, captan, propiconazole (36, 39). The population stability of PGPR when mixed with pesticides will likely also be influenced by PGPR strain and application method. Previous work has found that formulations impact PGPR survival and shelf life (40, 41). More research will need to be conducted with different bacterial genera, strains, formulations and pesticides to determine compatibility.

The demands for near perfect aesthetics and playability on golf courses and the lack of reliable cultural and biological controls or host plant resistance for mole crickets drive reliance on insecticides for management (3, 13, 42). Highly maintained areas may receive three chemical applications per year for mole crickets. Insecticide applications are made in response to early spring (February-April) or fall (September-October) activity of adults or during egg hatch and early nymphal stages (May-July) (24). Frequent pesticide applications on a univoltine insect can place substantial selection pressures on populations that may lead to reduced chemical efficacy and resistance. Application of PGPR as a biostimulant to increase the tolerance of bermudagrass to mole crickets could reduce selection pressure on these univoltine pests from repeated exposure to the same or similar mode of action. Our results suggest that PGPR applied frequently (monthly or weekly) as a biostimulant may enhance the vigor of bermudagrass such that insecticide applications for mole crickets may be reduced or unnecessary. Previous work in our lab suggests that these applications may also positively influence IPM by inducing changes in oviposition behaviors or fall armyworms (18), or tolerance to other root-feeding insects like white grubs (Coy R M, unpublished data). Our data further suggest that PGPR, if used as a biostimulant in managed turfgrass, would not likely be adversely affected by insecticides present in the soil water. Now, there are fewer PGPR products available for use in pasture or amenity grasses than for food or fiber crops. The global market for biostimulants, including PGPR is estimated to be $2 billion (USD) by 2018 (35). As this and previous work demonstrates the utility of PGPR for plant growth promotion and IPM, we anticipate products containing these beneficial microbes to become more widely available.

### REFERENCES

1. McKersie B, Planning for food security in a changing climate. J Exp Botany 66:3435-3450 (2015).
2. Myresiotis C K, Vryzas Z, and Papadopoulou-Mourkidou E, Effect of specific plant-growth-promoting rhizobacteria on growth and uptake of neonicotinoid insecticide thiamethoxam in corn (Zea mays L.) seedlings. Pest Manag Sci 71: 1258-1266 (2015).
3. Held D W, and Potter D A, Prospects for managing turfgrass pests with reduced chemical inputs. Annu Rev Entomol 57: 329-354 (2012).
4. Milesi C, Running S W, Elvidge C D, Dietz J B, Tuttle B T, and Nemani R R, Mapping and modeling the biochemical cycling of turf grasses in the United States. Environ. Manag. 36:426-38 (2005).
5. Bashan Y, De-Bashan L E, Prabhu S R, and Hernandez J P, Advances in plant growth-promoting bacterial inoculant technology-formulations and practical perspectives (1998-2013). Plant Soil doi:10.1007/s11104-013-1956-x (2014).
6. Coy R. M., D. W. Held, and J. W. Kloepper, Rhizobacterial inoculants increase root and shoot growth in ‘Tifway’ hybrid bermudagrass. J Environ. Hort 32:149-154 (2014).
7. Kasim W W, Osman M E, Omar M N, Ebd El-Daim I A, Bejai S, and Meijer J, Control of drought stress in wheat using plant-growth-promoting bacteria. J Plant Growth Reul 32:122-130 (2012).
8. Omar M N, Fang P, and Jia X M, Effect of inoculation with Azospirillum brasilense NO40 isolated from Egyptian soil on rice growth in China. Egypt J Agric Res 78:1005-1014 (2000).
9. Bailey D L, Held D W, Kalra A, Twarakavi N, and Arriaga F, Biopores from mole crickets (Scapteriscus spp.) increase soil hydraulic conductivity and infiltration rates. Appl Soil Ecol 94: 7-14 (2015).
10. Walker T J, and Ngo D, Mole crickets and pasture grasses: damage by Scapteriscus vicinus, but not by S. acletus (Orthoptera: Gryllotalpidae). Fla Entomol 65:105-110 (1982).
11. Frank J H, and Parkman J P, Integrated pest management of pest mole crickets with emphasis on the southeastern USA. Int Pest Manage Rev 4: 39-52 (1999).
12. Thompson S R, and Brandenburg R L, Tunneling responses of mole crickets (Orthoptera: Gryllotalpidae) to the entomopathogenic fungus, Beauveria bassiana. Environ Entomol 34: 140-147 (2005).
13. Braman, S K, Duncan R R, Hanna W W, and Hudson W G, Evaluation of turfgrasses for resistance to mole crickets. Hort Sci 35: 665-668 (2000).
14. Braman, S K, Pendlet A F, Carrow R N, and Engelke M C, Potential resistance in zoysiagrasses to tawny mole crickets (Orthoptera: Gryllotalpidae) Fla Entomol 77: 302-305 (1994).
15. Reinert, J A, and Busey P, Resistant varieties, in Mole crickets in Florida, ed. by Walker T J, Univ of Florida Agr Expt Stat, Gainesville, Bul 846: 35-40 (1984).
16. Bakker P A H N, Doornbos R M, Zamioudis C, Berendsen R L, and Pieterse C M J, Induced systemic resistance and the rhizosphere biome. Plant Pathol J 29: 136-143 (2013).
17. Kloepper J W, Ryu C M, and Zhang S, Induced systemic resistance and promotion of growth by Bacillus spp. Phytopathol 94: 1259-1266 (2004).
18. Coy R M, Held D W, and Kloepper J W, Bacterial inoculant treatment of bermudagrass alters ovipositional behavior, larval and pupal weights of the fall armyworm (Lepidoptera: Noctuidae). Environ Entomol 46: 831-838. (2017).
19. Biere A. and Bennett A E, Three-way interactions between plants, microbes, and insects. Func Ecol 27:567-573 (2013).
20. Pineda A, Zheng S J, van Loon J J A, and Pieterse C M J, Rhizobacteria modify plant-aphid interactions: a case of induced systemic susceptibility, Plant Biol 14: 83-90 (2012).
21. Pineda A, Zheng S J, van Loon J J A, Pieterse C M J, and Dicke M, Helping plants to deal with insects: the role of beneficial soil-borne microbes. Trends Plant Sci 15: 507-514 (2010).
22. Zehnder G W, Murphy J F, Sikora E J, and Kloepper J W, Application of rhizobacteria for induced resistance. Eur J Plant Pathol 107:39-50 (2001).
23. Zehnder G, Kloepper J, Yao, C, and Wei G, Induction of systemic resistance against cucumber beetles (Coleoptera: Chrysomelidae) by plant growth-promoting rhizobacteria. J Econ Entomol 90: 391-396 (1997).
24. Held D, and Cobb P, Biology and control of mole crickets. Ala Coop Ext Serv ANR-0716 (2016).
25. Short D E, and Koehler P G, A sampling technique for mole crickets and other pests in turfgrass and pasture. Florida Entomol 62: 282-283 (1979).
26. Cobb P P, and Mack T P, A rating system for evaluating tawny mole crickets, Scapteriscus vicinus Scudder, damage (Orthoptera: Gryllotalpidae). J Entomol Sci 242: 142-144 (1989).
27. Hertl P L, and Brandenburg R L, Effect of soil moisture and time of year on mole cricket (Orthoptera: Gryllotalpidae) surface tunneling. Environ Entomol 31: 476-481 (2002).
28. do Amaral F P, Pankievicz V C, Arisi A C, de Souxa E M, Pedrosa F, and Stacey G, Differential growth responses of Bracypodium distachyon genotypes to inoculation of plant growth promoting rhizobacteria. Plant Mol Biol 90: 689-697 (2016).
29. Crow W T, Effects of a commercial formulation of Bacillus firmus 1-1582 on golf course bermudagrass infested with Belonolaimus longicaudatus. J Nematol 46: 331-335. (2014)
30. Fike C L, Nutritive quality of Coastal bermudagrass treated with plant growth-promoting rhizobacter. [Master's Thesis] Auburn, Auburn University (2017). https://etd.aubum.edu/handle/10415/5595
31. Pineda A, Dicke M, Pieterse C M J, and Pozo M J, Beneficial microbes in a changing environment: are they always helping plants to deal with insects? Funct Ecol 27: 574-586 (2013).
32. van de Mortel J E, de Vos R C H, Dekkers E, Pineda A, Guillod L, Bouwmeester, van Loon J J A, Dicke M, and Raaijmakers J M, Metabolic and transcriptomic changes induced in Arabidopsis by the rhizobacterium Pseudomonas flourescens SS101. Plant Physiol 160: 2173-2188 (2012).
33. Lindlow S E, and Brandl M T, Microbiology of the Phyllosphere. Appl Environ Microbiol 69:1875-1883 (2003).
34. Reva O N, Smirnov V V, Pettersson B, and Priest F G, Bacillus endophyticus sp. nov., isolated from inner tissues of cotton plants (Goddypium sp.) Int J Syst Evol Microbiol 52: 101-107 (2002).
35. Calvo P, Nelson L, and Kloepper J W, Agricutlural uses of plant biostimulants. Plant Soil 383:3-41 (2014).
36. Patil B V, Naik M K, Manujnath H, and Hosamani A C, Formulation and compatibility of PGPR with pesticides for suppression of insect pests, in Recent Advances in biofertilzers and biofungicides for sustainable agriculture, ed. by Reddy M S, Ilao R O, Faylon P S, Dar, and Batchelor W D, Cambridge Scholars Publishing, pp. 269-280 (2014).
37. Kumar K, Santharam G, and Sridhar R, Compatibility of imidacloprid with plant pathogenic antagonistic microorganisms, Trichoderma viride (Pers) and Pseudomonas fluorescens (Migula) in cotton. Asian Biol Sci 3: 171-175 (2008).
38. Jayakumar J, Ramakrishnan S, and Rajendran G, Evaluation of Pseudomonas fluorescens strains isolated from cotton rhizosphere against Rotylenchus reniformis. Indian J Nematol 34:206-208 (2004).
39. Khan M A, and Gangopadhyay S, Efficacy of Pseudomonas fluorescens in controlling root rot of chickpea caused by Macrophomina phaseolina. J Mycol Plant Pathol 35: 580-587 (2008).
40. Shivakumar G, Sharma R C, and Rai S N, Biocontrol of banded leaf and sheath blight of maize by peat based Pseudomonas fluorescens formulation. Indian Phytopathol 53: 190-192 (2000).
41. Kloepper J W, and Schroth M N, Development of powder formulation of rhizobacteria for inoculation of potato seed pieces. Phytopathol 71: 590-592 (1981).
42. Hudson W G, Frank J H, and Castner J L, Biological control of Scapteriscus spp. mole crickets (Orthoptera: Gryllotalpidae) in Florida. Am Entomol 34: 192-198.

### Example 2—Manipulating Microbial Ecology: How Plant Growth-Promoting Rhizobacteria can Benefit Turfgrass Management

Water and fertilizer use for turfgrass and horticultural commodities is a local, state, and national concern for these industries. Water availability for irrigation has decreased in recent years due to greater demands from agriculture, industry, domestic uses, and climate variability. Additionally, increasingly stringent state and federal regulations often limit water or chemical inputs for managing amenity crops, including turfgrass. These catalysts are driving the need for, and adoption of, management strategies to conserve water or increase use efficiency. Conservation has been the cornerstone of best management practices emphasizing preservation, sustainability, and environmental stewardship. However, new biological technologies in development may further advance reduced inputs in turfgrass. Development and integration of these biologicals can positively change the ability of grasses to tolerate abiotic and biotic stresses, while reducing chemical and water needs. Coupling these biological innovations with environment stewardship goals could allow for the maintenance of high quality turfgrasses under adverse conditions with limited resource input.

Incorporation of plant biostimulants or biofertilizers into management practices are possible avenues to maintain high quality turfgrasses. European and North American definitions of biostimulants vary due to the wide array of substances classified as biostimulants. Typically, distinctions are made between biostimulants and biopesticides for regulatory purposes based on their agricultural use. Biostimulants in North America are defined as substances, including microorganisms, that when applied to plants, seeds, and soil may integrate applied nutrients, or provide benefits to plant development. They are not considered plant nutrients and therefore may not make any nutritional claims or guarantees. This lack of claims or guarantees should not be misinterpreted as a lack of research. Reported impacts of biostimulants on plants include enhanced growth and development; improved nutrient uptake and efficiency or reduced nutrient losses; improvement in soil structure, function, or performance. Previous work with biostimulants in turfgrass focused on seaweed extracts, plant hormones, and humic acid; however, living-biostimulants that manipulate or augment soil microbes are gaining popularity. Living-biostimulants colonize and persist in plants or soil, yielding growth benefits and, in some cases, negative impacts on insect pests and nematodes. For example, Bacillus sphaericus, induces growth promotion and stress mitigation in many crops, including turfgrasses (hybrid bermudagrasses and tall fescue). It is also a larvicide against mosquitoes and an ovipositional deterrent against the fall armyworm-complicating the distinction between a biostimulant and a biopesticide.

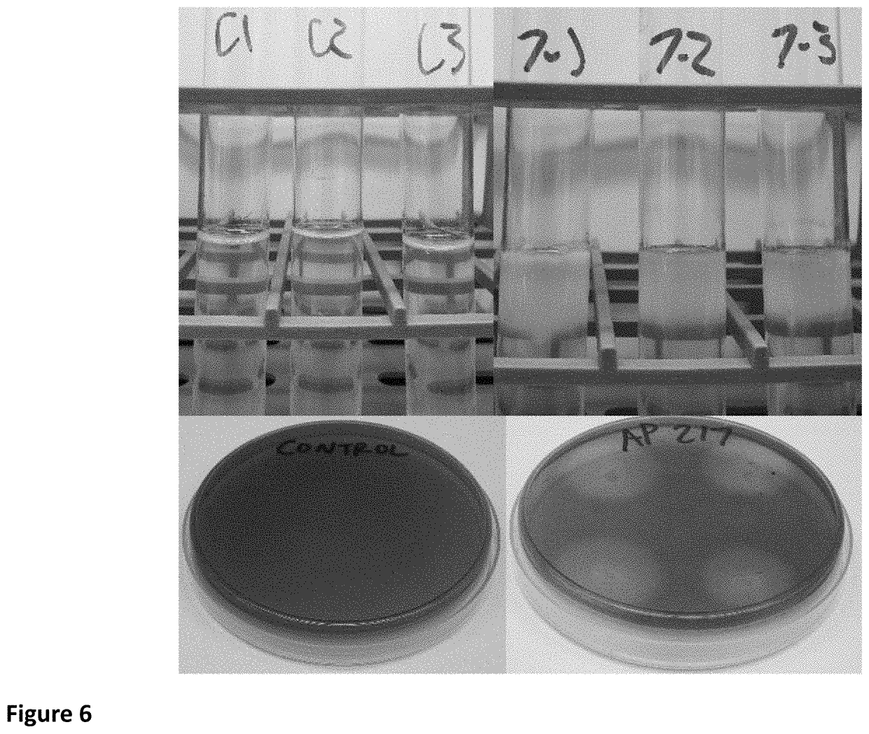

Living biostimulants including arbuscular mycorrhizal fungi (AMF) and bacteria called plant growth-promoting rhizobacteria (PGPR) have been the most studied. These living biostimulants are epiphytic (capable of living on plant surfaces), endophytic (capable of living within the plant tissue) or both. Researchers isolate and culture these non-pathogenic microbes from soil, plants, plant residues, water, and composted manures. Once isolated, soil, whole plants or seeds can be inoculated with these microorganisms to observe plant responses. Soil microbial communities are intimately associated with plants, influencing health, biomass accumulation, soil quality, and nutrient availability and acquisition. The microbial communities in the rhizosphere (layer of soil that is influenced by the plant root) are highly specialized and influenced by climate, soil type and characteristics, and ground cover. Certain microbes, when present or dominant, can induce changes in plants and influence plant-microbe interactions. Changes in plant growth resulting from inoculation with PGPR may result from nitrogen fixation, phosphate solubilization, siderophore production, or upregulation of signal pathways in plants (FIG. 6). PGPR have been linked to drought mitigation through priming plant signaling defenses which alter plant-water regulation, use, and efficiency; production of larger, more explorative root systems; synthesis of phytohormones (cytokinins, auxins, gibeberellins, ethylene, etc.), or by the production of secondary metabolites.

While the bacteria and their effects on plants are not new, research with PGPR as a living biostimulant in turfgrass is in its infancy. Interactions of bacteria with plants may lay the groundwork for novel solutions to several different issues in turfgrass culture. PGPR are non-pathogenic, beneficial, free-living soil- and root-inhabiting bacteria that colonize seeds and roots in the rhizosphere. The rhizosphere has a greater density of organic carbon and bacteria than the rest of the bulk soil, allowing for the plant's roots to secrete root exudates and metabolites that can be used as plant nutrients. Because the rhizosphere bacterial community is richer than bulk soil, competition exists between microbes for limited soil nutrients and space for colonization on the root. To have a positive impact on the plant, inoculants must have high bacterial concentrations and be formulated for the stability of these bacteria to compete and augment the soil microbial community once applied. Successful rhizobacterial inoculants must survive through formulation and inoculation, and then multiply and colonize the developing root system once applied. In our turfgrass work so far, rhizobacterial inoculants have been shown to consistently increase root biomass and in several bermudagrasses (Coastal, Tifway, LaPaloma, Yukon) and tall fescue (KY 32). They may also mediate plant-microbe-insect interactions with several turfgrass pests (fall armyworms, grubs, and mole crickets), while altering water regulations during drought stress compared to untreated and fertilized grasses.

Abiotic and biotic conditions can change frequently presenting challenges that plants must overcome. To deal with this, plants engage sophisticated physiological, cellular, biochemical, and molecular responses to maintain homeostasis under harsh conditions. Turfgrass exposure to abiotic stress decreases aesthetic quality, functionality, and playability. Environmental stress in grasses often results from temperature, water, and light stress, or from poor soil quality. Drought, salinity, and temperature stresses alter plant physiology and metabolic responses, limiting growth, productivity, and survival. Turfgrass responses to stress at the whole plant or cellular level is vital for the development of new grass cultivars and for the incorporation of novel technologies into management practices. Living biostimulants like PGPR have an advantage over traditional breeding; they can be applied responsively to stress. Drought for example is unpredictable and temporary. Application of PGPR, for example, can provide benefits in the same season regardless of cultivar.

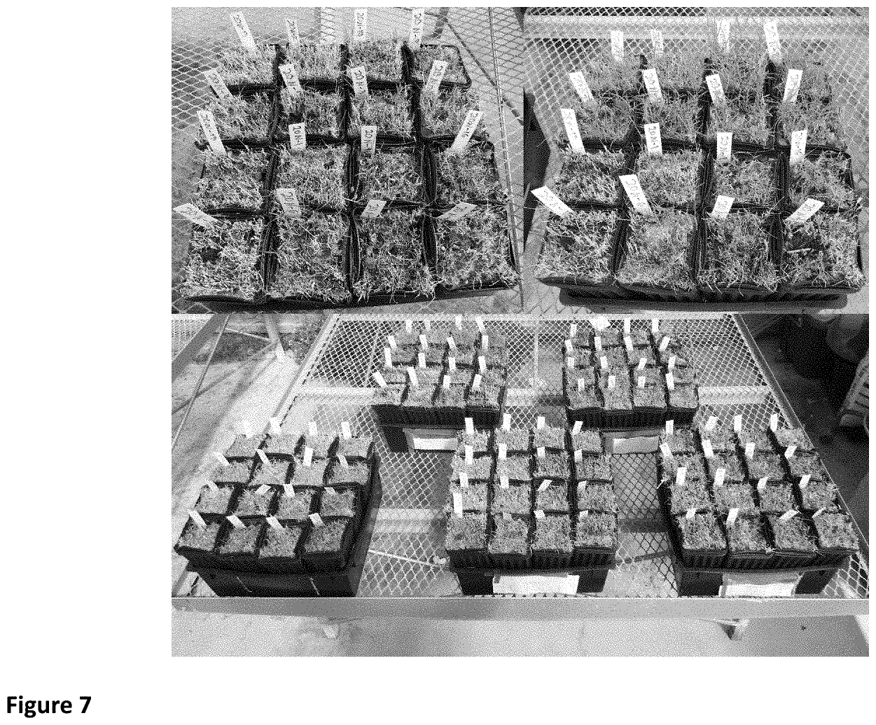

Our lab has recently evaluated PGPR for drought interactions, mitigation, and recovery with three bermudagrass cultivars (Tifway, LaPaloma, and Yukon). Differences between rhizobacterial inoculants (blends) as well as differences between bacteria-treated, untreated, and fertilized plants in chlorophyll content, water regulations, electrolyte leakage, and root growth suggest bacteria play vital roles in stress mitigation in bermudagrass (FIG. 7). Furthermore, we are exploring the soil microbial community for new bacteria. In the summer of 2016, an extreme drought occurred in Alabama, providing the opportunity to sample amenity turfgrasses, native grasses, and weeds that maintained desirable physiological characteristics. The sampling of the plants lead to the isolation of 604 bacterial strains that may be associated with drought tolerance and mitigation in grasses.

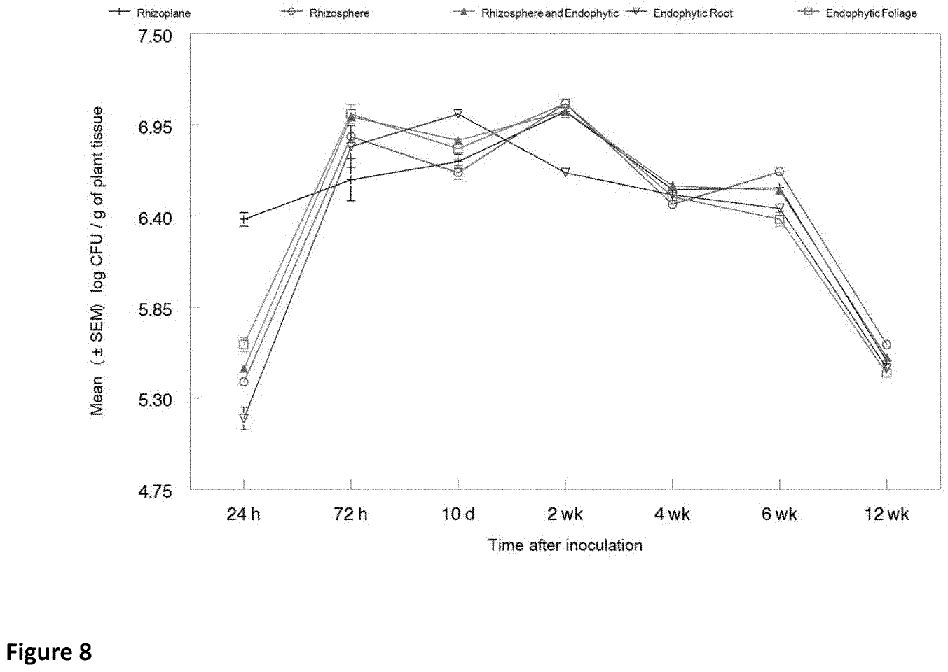

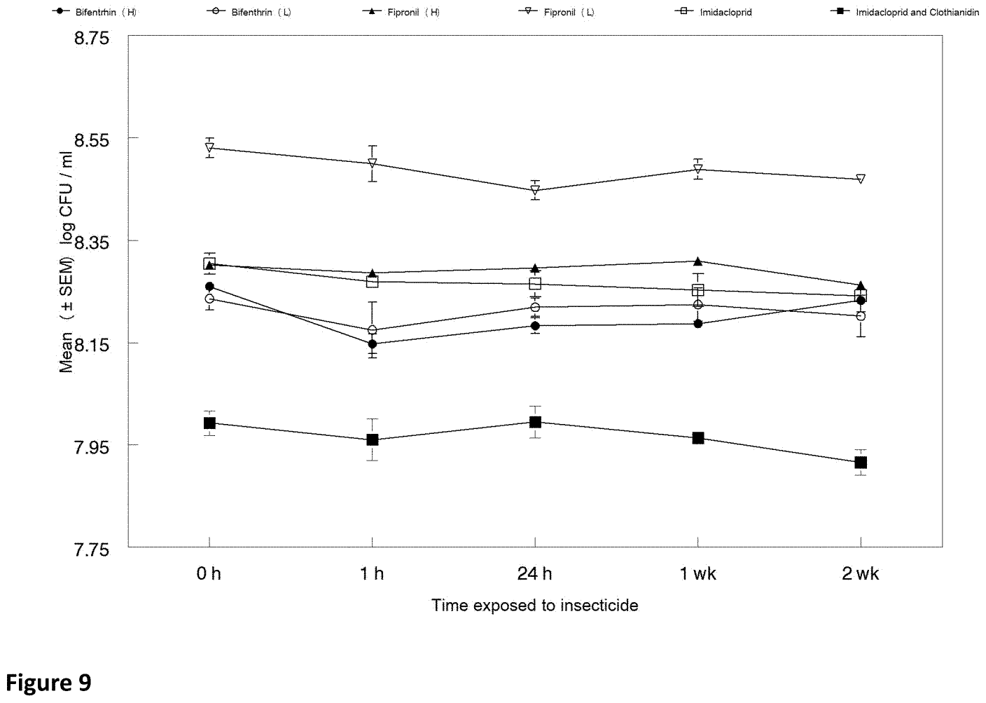

Products marketed with PGPR are formulated as single species of bacteria or as blends of multiple species or strains. The products may be available as a liquid or granule and are compatible with most chemicals already used. Studies monitored the stability of the bacterial populations mixed with neonicotinoids, phenypyrazole, and pyrethroid insecticides over two weeks (FIG. 8). Often the bacteria are formulated with a compliment of plant nutrients that aid in bacterial growth and population longevity. For example, Bayer Environmental Sciences introduced Nortica®, Bacillus firmus, a single species biofertilizer (0.1 lb N/1,000 ft²; 14-0-21) and biopesticide granular product for enhanced growth and nematode control in turfgrass. Recent research tracked the epiphytic and endophytic colonization and populations of non-commercial rhizobacteria under field conditions applied to common bermudagrass in a loamy sand over a 12-week period (FIG. 9). Beyond the compatibility with fertilizers and insecticides, PGPR (Bacillus subtilis) have been linked to a 38-65% increase in root biomass and increased uptake and efficiency of a neonicotinoid (thiamethoxam) in corn seedlings. The increase in use efficiency could lead to lower use rates of systemic pesticides.

While research with PGPR is relatively new in turfgrass, the biostimulant market is growing with an expected market value of $2.2 billion in 2018. As recent as 14 September, Bayer announced a $100M partnership with a Ginkgo Bioworks, a microbe genetic engineering company that markets endophytic bacteria for nitrogen fixation. The compatibility of microbes with current technology and the recent insights into benefits for crops and grasses demonstrates the ability and need to incorporate these technologies into management practices.

Research

PGPR, Nitrogen Fixation and Siderophore Production

Qualitative nitrogen fixation activity of bacteria was evaluated in a nitrogen-free semisolid media (NFb). This allows us to observe if bacteria can fix nitrogen in an oxygen gradient. Growth characteristics of a pellicle in the media indicate nitrogen fixation. Single bacterial colonies were introduced to the NFb semisolid media and monitored for 48-72 hr.

Qualitative siderophore production of bacteria was evaluated with Chrome azurol S (CAS) agar. Bacteria were grown on growth media for 24 hr and then single colonies were transferred to quadrants on the CAS media. Orange halos growing around the bacteria colonies confirmed siderophore production by the bacteria after 48-72 hr.

PGPR and Insecticide Compatibility

Bacterial strains from multiple genera with known populations (minimum of 1×10⁸ colony forming units (CFU)/ml (0.03 oz)) were evaluated individually for their compatibility with commonly turfgrass insecticides. Bacteria were individually mixed in 50 ml (1.69 oz) centrifuge tubes with three different insecticide classes (neonicotinoids, phenylpyrazole, pyrethroid) based on label rates (high and low, when applicable). Samples were taken from each solution after 1 hr, 24 hr, 1 wk, and 2 wk. Samples were then transferred to glass tubes with sterile water and serially diluted. Samples were transferred to growth media for 24 hr before populations were estimated based on bacterial colony counts. Results presented show the bacterial populations from the Bacillus pumilus AP 7 samples demonstrating the compatibility with common insecticides. These data trends in population stability were typical of all bacteria tested. Bacterial populations are graphed as their log CFU/ml, for example a log value of 8 is equal to 1×10⁸.

PGPR and Drought Tolerance

Greenhouse studies were designed to evaluate drought responses of bacteria-treated, bacteria-treated with 50% nitrogen, 50% nitrogen, fully fertilized, and untreated bermudagrasses with varying drought tolerances LaPaloma (moderately tolerant) and Yukon (susceptible). Blend 20, a mixture of three bacterial strains (Bacillus pumilus AP 7, Bacillus pumilus AP 18, and Bacillus sphaericus AP 282) was used in this study. Previous studies evaluated Tifway (tolerant). Grasses were established for a month, and then treated for 5 wk before drought exposure for 3 wk. Experiments assessed changes in chlorophyll, relative water content, electrolyte leakage (pre, during, and post-drought), and root parameters (biomass, length, surface area, volume). After the drought period, grasses recovered for 3 wk. During recovery, half of the potted grasses had treatments reapplied and the other half only recovered with water during recovery to determine if reapplication was necessary. Results suggest that reapplication of treatments is necessary to aid in recovery. Differences were detected between grasses that were and were not retreated as well as treatment and cultivar differences.

### References

Bashan, Y., L. E. de-Bashan, S. R. Prabhu, J-P. Hernandez. 2014. Advances in plant-growth promoting bacterial inoculant technology: formulations and practical perspectives (1998-2013). Plant Soil. 378:1-33.
Calvo, P. L. Nelson, and J. W. Kloepper. 2014. Agricutlural uses of plant biostimulants. Plant Soil. 383:3. DOI: 10.1007/s11104-014-2131-8.
Coy, R. M., D. W. Held, and J. W. Kloepper. 2014. Rhizobacterial inoculants increase root and shoot growth in ‘Tifway’ hybrid bermudagrass. J. Environ. Hort. 32:149-154.
Coy, R. M., D. W. Held, and J. W. Kloepper. 2017. Bacterial inoculant treatment of bermudagrass alters ovipositional behavior, larval and pupal weights of the fall armyworm, Spodoptera frugiperda (Lepidoptera: Noctuidae). Environmental Entomology. 46: 831-838.
Du, H., Z. Wang, W. Yu, and B. Huang. 2012. Metabolic responses of hybrid bermudagrass to short-term and long-term drought stress. J. Amer. Soc. Hort Sci. 137:411-420.
Hu, L., Z. Wang, and B. Huang. 2009. Photosynthetic responses of bermudagrass to drought stress associated with stomatal and metabolic limitations. Crop Sci. 49: 1902-1909.
Gagné-Bourque, F., B. F. Mayer, J-B. Charron, H. Vali, A. Bertrand, and S. Jabaji. 2015. Accelerated growth rate and increased drought stress resilience of the model grass Brachypodium distachyon colonized by Bacillus subtilis B26. PLoS ONE 10(6): e0130456. DOI:10.1371/journal.pone.0130456.
Kasim, W. W., M. E. Osman, M. N. Omar, I. A. Ebd El-Daim, S. Bejai, & J. Meijer. 2012. Control of drought stress in wheat using plant-growth-promoting bacteria. J. Plant Growth Reul. 32:122-130.
Kaushal, M., and S. P. Wani. 2016. Rhizobacterial-plant interactions: strategies ensuring plant growth promotion under drought and salinity stress. Agric. Ecosys. Environ. 231: 68-78.
Myresiotis, C. K., Z. Vryzas, and E. Papadopoulou-Mourkidou. 2015. Effect of specific plant-growth promoting rhizobacteria (PGPR) on growth and uptake of neonicotinoid insecticide thiamethoxam in corn (Zea mays L.) seedlings. Pest Manag. Sci. 71: 1258-1266.

### Example 3—Rhizobacterial Treatment of Tall Fescue and Bermudagrass Increases Tolerance to Damage from White Grubs

Reference is made to Coy et al., “Rhizobacterial treatment of tall fescue and bermudagrass increases tolerance to damage from white grubs,” Pest Manag Sci 2019; 75:3210-3217, 7 Apr. 2019; the content of which is incorporate herein by reference in its entirety.

Abstract

BACKGROUND: Inoculation of hybrid bermudagrass with plant growth-promoting rhizobacteria (PGPR) can increase plant growth and influence relationships with above-ground herbivores like fall armyworms. However, few experiments have evaluated PGPR applications relative to root herbivory. Root-feeding white grubs cause severe damage to grasses, especially in tall fescue pastures, golf courses, and lawns. Since bacterial inoculants enhance root growth, the goal of this study was to determine if the inoculation of hybrid bermudagrass by rhizobacteria can increase the tolerance of tall fescue and hybrid bermudagrass to damage from white grub feeding, and if PGPR are compatible with neonicotinoid insecticides commonly used for white grub control.

RESULTS: In trials with tall fescue and hybrid bermudagrass, grasses were treated with the PGPR strain mixture Blend 20 or nitrogen or left non-treated and were then infested with Japanese beetle grubs. Grasses treated with PGPR and nitrogen fertilizer produced significantly more top growth than the non-treated grub-infested controls. Tall fescue and hybrid bermudagrass treated with Blend 20 produced root mass similar to or greater than nitrogen fertilized grasses. Both grasses treated with Blend 20 had greater root mass than non-treated infested grass. No treatment negatively impacted grub survival, and weight gains of grubs were similar for all treatments. Bacterial strains were typically compatible with insecticides used to control white grubs.

CONCLUSION: PGPR and nitrogen fertilization stimulate root growth resulting in tolerance of tall fescue and hybrid bermudagrass to white grub infestation. PGPR, acting as biostimulants to increase root biomass on grasses, may have utility for IPM of root herbivores.

Introduction

White grubs (Coleoptera: Scarabaeidae) are serious pests of grasses grown for pasture, golf courses, sod production, and lawns (1-3). Most species are univoltine, developing underground as root-feeding larvae for 9-10 months. As larvae, particularly larger 2nd and 3rd instars, feeding increases on roots, and grasses are unable to maintain normal water relations resulting in wilting or even stand loss (1). Due to the subterranean nature and feeding of white grubs, damage can be unnoticed until substantial root loss has occurred, resulting in abrupt and severe damage (1). Control of soil insects is challenging as the insecticide must move through the turf canopy and thatch to enter the root zone, root, or contact the pest directly, often requiring post-treatment irrigation for efficient control. Potential losses from white grubs in turfgrass drive control practices that focus on damage prevention. Preventative control measures rely on the application of insecticides, often neonicotinoids, around the time of egg hatch but before white grubs are detected (1,3). Neonicotinoid insecticides applied for preventative control of white grubs have consequences for insect pollinators and beneficials, and soil-dwelling invertebrates (4-7). These non-target impacts of grub control create opportunities for alternatives such as increasing plant tolerance to damage.

Biologicals that enhance plant resistance or tolerance to abiotic and biotic stresses could minimize environmental consequences while reducing chemical and water input needs (8). Traditionally, improvements in turfgrass cultivars for increased adaptability, aesthetics, and playability, as well as limited disease and stress resistance have been the focus of grass breeding programs. However, there are limited successes related to grass-feeding insects and particularly root-feeding herbivores (9). For example, infection of perennial ryegrass and fescue by fungal endophyte species in the genus Epichloë enhanced resistance to certain folivores, but the impacts of fungal endophytes appear to have subtler, nonlethal effects on root-feeders (10,11).

Inoculation of turfgrasses with elicitors or biostimulants may result in increased pest tolerances or desirable plant phenotypes by maintaining color, productivity, and playability despite pest pressure. Products applied to existing grass when needed would potentially yield results easier and faster than traditional breeding programs. Plant growth-promoting rhizobacteria (PGPR) have been used as inoculants for the maintenance of high quality crops, including grasses (Poaceae) under normal and adverse conditions with limited resource input (12-14). In previous work, Coy et al. (12) noted greater root mass, volume and length of bermudagrass treated with PGPR compared to non-treated bermudagrass. However, greater root mass alone may not always convey tolerance to white grubs (15-17). Cultivars of seashore Paspalum (Paspalum vaginatum Swartz), a warm-season grass were more tolerant of feeding by Japanese beetle grubs but did not have a greater root mass (16). Cool-season grass varieties with larger root biomass had greater tolerance to grubs of European chafer (Rhizotrogusmajalis Razoumosky) but also yielded larger grub mass (15,17). Larger root masses may have proportionately the same loss as smaller root systems but yield large grubs.

Studies investigating the interactions between plants and PGPR have primarily focused on plant growth promotion and the suppression of plant pathogens by rhizobacterial strains (18,19). More recently, studies have extended these interactions to determine the impact of PGPR on insect folivores (20-26). Thus far, virtually no PGPR research has been conducted on soil-dwelling or root-feeding insects. This lack of research is probably due to the logistical challenges of direct observations of subterranean pests, but the plant-microbe-insect interactions may be more impactful for subterranean insects in close association and constant exposure to rhizobacteria. Because of their association with grass roots, white grubs are an interesting model system to explore these effects with an economically-important pest. Due to the range of its establishment and host range, P. japonica is one of the most extensive and destructive pests of turfgrass and landscape plants in the United States, with annual control costs exceeding $450 million USD (3,27). Japanese beetles utilize all common species of grasses and lawn weeds for larval development (28-32). Using Japanese beetle grubs in tall fescue and bermudagrass systems, we determined if inoculation of these grasses by PGPR can negatively impact Japanese beetle survival and increase plant tolerance to a below-ground insect herbivore. We also determined if PGPR would be compatible with current commonly used insecticides for Japanese beetle control.

2. Materials and Methods

2.1 Bacterial Strains and Inoculant Preparation

Experiments were conducted with Blend 20, an aqueous mixture, containing equal parts of three PGPR strains (Bacillus pumilus AP 7, B. pumilus AP 18, and B. sphaericus AP 282) that induce growth promotion in bermudagrass (12,20). Bacterial strains stored at −80° C. were transferred from cryovials to plates of tryptic soy agar (TSA) and allowed to grow at 28° C. in an incubator. After 24-48 h, bacterial lawns were scraped from TSA plates with inoculating loops and transferred to either new TSA plates or to sterile centrifuge tubes (50 mL, VWR, Radnor, Pa.) containing 40 mL of sterile water, and vigorously shaken to evenly distribute bacterial cells. Serial 10-fold dilutions were then made of each bacterial suspension in sterile water to a final dilution of 10⁻⁵.

Bacterial populations (number of colony forming units [CFU]) in the suspensions were determined by plating 50 μL of the serial dilution onto TSA plates, incubating plates for 24-48 h, and then counting the number of bacterial colonies on each plate. Once the concentrations (CFU per ml) in the prepared suspensions of each strain were determined, these populations were used to make bacterial stock solutions for each strain. Stock solution of the bacterial blend was prepared by the addition of one liter of equal parts of each bacterium to achieve a blend with a final concentration of 1×10⁷ CFU per ml of each strain.

2.2 Bacterial Strains and Insecticide Compatibility

The strains that comprise Blend 20, each with aminimum concentration of 1×10⁸ CFU per ml, were individually evaluated for their compatibility with commonly used liquid neonicotinoid insecticides. The strains within the blend were evaluated individually to make recovery of each bacterium apparent, as the colony morphologies are similar. Freshly prepared bacteria stock solutions were evaluated for survival when mixed with three different insecticides mixed in separate 50 mL centrifuge tubes for 1 and 24 h, and 1 and 2 wk at 25° C. under ambient light. Bacteria and pesticide solutions were prepared based on the label recommendations for volume of area covered. The pesticides evaluated were imidacloprid (Ferti-lome® Tree and Shrub Systemic Insect Drench, 1.47% active ingredient, Voluntary Purchasing Groups, Inc., Bonham, Tex., USA), imidacloprid (Merit® 2F, 21.4% active ingredient, Bayer Environmental Sciences, Research Triangle Park, N.C., USA), and imidacloprid and clothianidin (Bayer Advanced 12 Month Tree and Shrub Protect and Feed II®, 0.74% imidacloprid and 0.37% clothianidin active ingredient, Bayer Environmental Sciences). The Ferti-lome® product was mixed at a rate of 89 mL of product per 3785 mL. Merit® 2F was mixed at a rate of 17 mL of product per 92.9 m². Bayer Advanced Tree and Shrub Protect and Feed II® was mixed at a rate of 89 mL of product per 3785 mL.

After the allotted time, the centrifuge tubes were vigorously shaken to evenly distribute bacterial cells before completing five serial 10-fold dilutions. Serial dilutions were made of each bacterial suspension into sterile water blanks to a final dilution of 10⁻⁵. Bacterial populations (number of colony forming units [CFU]) in the suspensions were determined by plating 50 μL of the 10⁻⁵ serial dilutions onto three TSA plates, incubating plates for 24 h and then counting the number of CFU on each plate.

2.3 Sources of Insects and Preparation

First and second instar Japanese beetle grubs were field collected from infested turf on a golf course in Evansville, Wis. Grubs were collected and placed in groups of 25 in plastic containers (10.2 cm diameter×15.2 cm tall) containing a 1:1 ratio of Sunshine #2 Natural and Organic (Canadian sphagnum peat moss, perlite, vermiculite, dolomitic limestone, and wetting agent, Sun Gro Horticulture, Agawam, Mass., USA) and Fafard Canadian Sphagnum Peat Moss (Sun Gro Horticulture) with a 16-22% soil moisture by volume and placed in a cooler for transport back to the lab. The organic matter from the mixture of Sunshine #2 and peat moss was the food source for the developing grubs. Once in the lab, grubs were transferred to individual containers (44 mL, 5.1 cm diameter×8.7 cm tall) with the same soilless mixture and held for 7-10 d in a growth chamber at 23.5° C. 14:10 (L:D) photoperiod. At the start of the experiments, grubs were weighed individually and grouped into replicates based on initial mass.

2.4 Assessment of PGPR on White Grub Survival

Two experiments were conducted to determine possible insecticidal activity of the strains present in Blend 20 against first and second instar grubs of Japanese beetles. Since white grubs consume roots and soil during feeding that may contain rhizobacteria, these experiments determined if contact with or ingestion of PGPR in the soil would impact survival of white grubs. In the direct application experiment, 25 (late first to early second instar) white grubs with an average mass of 38.7 mg were selected and each grub had 1 mL of 1×10⁷ CFU/ml of Blend 20 pipetted directly over its body on wax paper before being returned to its individual container. Any excess bacterial solution that was pipetted over the grub was poured over the grub's body and soil mixture when it was returned to its container. Applications were made to each grub twice during the first week, with a 3 d interval, and grubs were monitored for 3 wk for survival. The experiment evaluating the effects of PGPR in the soil placed 25 grubs in individual containers with the 1:1 ratio of Sunshine mix #2 and peat moss. A solution of PGPR was the only source of moisture in these containers forcing grubs to contact and consume PGPR. Containers were weighed every other day and soil moisture was replenished with a hand sprayer of distilled water or PGPR stock solution to maintain a 16-22% soil moisture by volume. Initial weights of white grubs in this study ranged from 35.4-88.7 mg. After 3 wk, grubs were removed from each cup and survival was assessed. No additional food sources were provided for the grubs during the experiment.

2.5 Evaluation of Tolerance to White Grubs in Tall Fescue and Bermudagrass

Two trials in the summer of 2016 evaluated one PGPR blend (Blend 20), nitrogen-fertilized, and non-treated cool and warm-season grasses. The first trial evaluated ‘KY 32,’ a cool-season, endophyte free tall fescue (Festuca arundinacea Schreb) variety and the second trial evaluated ‘Tifway’ hybrid bermudagrass (Cynodon dactylon (L.) x C. transvaalensis Burtt-Davy), a warm-season variety. The selection of a non-endophytic tall fescue (KY 32) was deliberate for this work to avoid possible interactions between PGPR and fungal endophytes in tall fescue.

The tall fescue trial was conducted in a growth chamber set at 23.5° C. and a 14:10 (L:D) photoperiod. Styrofoam cups (9.0 cm diameter×15.5 cm depth) were filled with loamy sand field soil obtained from a research field at E.V. Smith Research Center (Shorter, Ala., USA) and seeded at a rate of 33.6 kg/ha. Seeded cups were placed in the growth chamber maintained at 16-22% soil moisture by volume. The grasses were grown for 3 wk before being infested. During that time, plants were fertilized twice with granular ammonium sulfate fertilizer (5.81 g of product (1.22 g N/m2), PRO fertilizer, 21-0-0; Harrell's Inc., Lakewood, Fla., USA). Plants were not cut until new grass growth exceeded 5 cm. After 3 wk, grass containers were infested with one second instar white grub (˜17 grubs per 0.1 m2). with an average weight of 66.67 mg.

The tall fescue trial had 30 replicates per treatment and the bermudagrass trial had 20 replicates per treatment in a randomized complete block design. Within each replicate, grub weights were within 1-2 mg of one another. Immediately after infesting cups with grubs, treatments were randomly assigned, and the first treatments were applied. Grasses assigned to PGPR treatments received weekly treatments of 3 mL (500 mL/m²) of bacterial suspension for 4 wk. The same volume of distilled water was applied to the control plants each week. Both PGPR and distilled water were pipetted over the grass. Grasses assigned to the fertilizer treatment received 5.81 g of product granular ammonium sulfate fertilizer weekly. After each treatment application, each cup received 80 mL (1.27 cm) of water to move the treatment to the root zone. Except when applications were made, cups were weighed every 3 d and then watered as needed.

For the bermudagrass trial, Tifway hybrid bermudagrass plugs (3.8 cm diameter) were harvested from the Auburn University Turfgrass Research Unit, Auburn, Ala., USA. After harvesting, plugs were washed free of field soil and transplanted into square plastic pots (7.6 cm diameter×20.3 cm depth; MT38 Mini-Treepots, Stuewe and Sons, Tangent, Oreg.) filled with loamy sand field soil. Plants were grown in a green house with an average temperature of 28.6±5° C., 14:10 (L:D), 50% average relative humidity. The grass was grown for 3 wk during which time plants were cut weekly to a height of 3.7 cm and fertilized weekly with ammonium sulfate fertilizer at rate of 5.81 g of product/m². After 3 wk, grasses were infested with one second instar white grub with an average weight of 46.35 mg. Methods for this experiment followed as previously described and the experiment lasted 8 wk.

Once treatments began, tall fescue plants were cut weekly to a height of 5 cm, and Tifway bermudagrass was cut every other week to a height of 3.7 cm. Grass top growth clippings were collected and weighed for leaf fresh mass and then oven dried at 70° C. for 72 h before being reweighed for dry mass (12) To avoid any temperature or lighting bias, grass plants in cups (growth chamber) and pots (greenhouse) were rotated on a weekly basis.

At the end of each trial, plants were destructively sampled to recover white grubs and root systems. Grubs were reweighed for final mass. The root system of each plant was washed in the lab and weighed for fresh mass and then oven dried at 70° C. for 72 h before being reweighed for dry mass.

2.6 Statistical Analysis

Fresh and dry mass of top growth in each trial were analyzed separately using repeated measures of multivariate analysis of variance (MANOVA), followed by single degree of freedom orthogonal contrasts for comparisons of treatments (P<0.05, IMP Version 13. SAS Institute Inc., Cary, N.C., USA). Repeated measures analyses compare the mass of top growth from a single treatment over time. Because of the structuring of treatments, orthogonal contrasts were used to compare individual treatments or a single treatment against the combination of other treatments. Japanese beetle grub mass, root fresh and dry mass were analyzed using analysis of variance (ANOVA), Student's t-test (P<0.05). The analyses compared the final grub mass (change in mass) or the root masses of a single treatment to the other individual treatments or a single treatment against the combination of other treatments. Bacterial populations in the insecticide solutions were analyzed using a paired sample t-test (P<0.05) for each time interval.

3. Results

3.1 Assessment of PGPR on White Grub Survival

The direct application of PGPR to Japanese beetle grubs and continued feeding and exposure of grubs for 3 wk to PGPR was not found to be toxic, with 100% survival for both treatments. Additionally, direct observation of grubs did not reveal any symptoms associated with morbidity (e.g., discoloration). After 3 wk and two topical applications, white grubs averaged a 268% increase in mass from an average of 38.7 mg to a final average weight of 103.7 mg. White grubs recovered were third instars.

3.2 Bacteria and Insecticide Compatibility

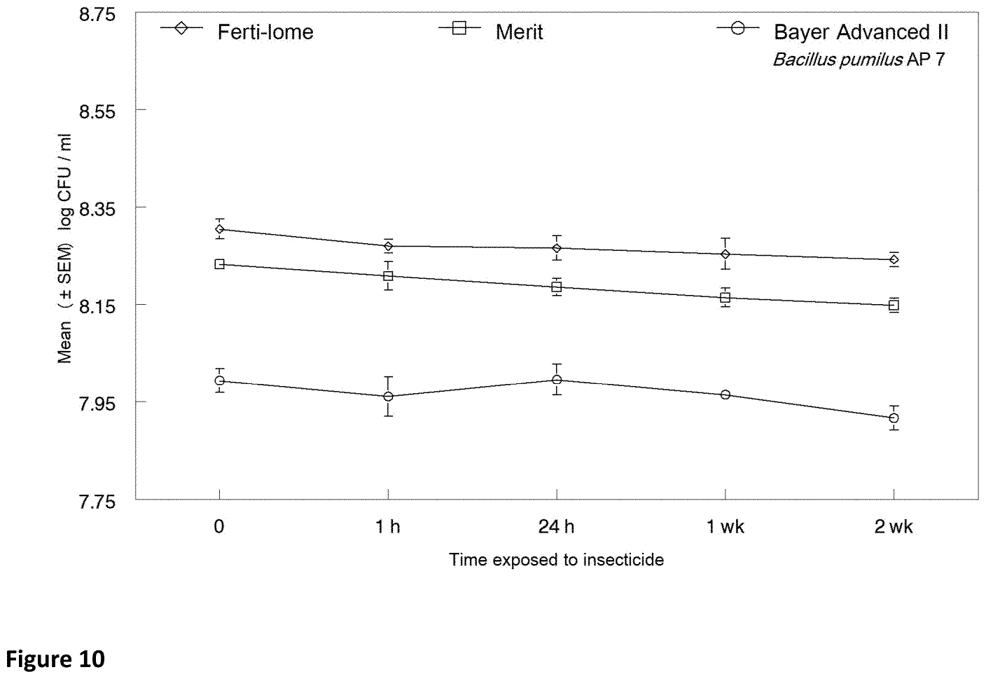

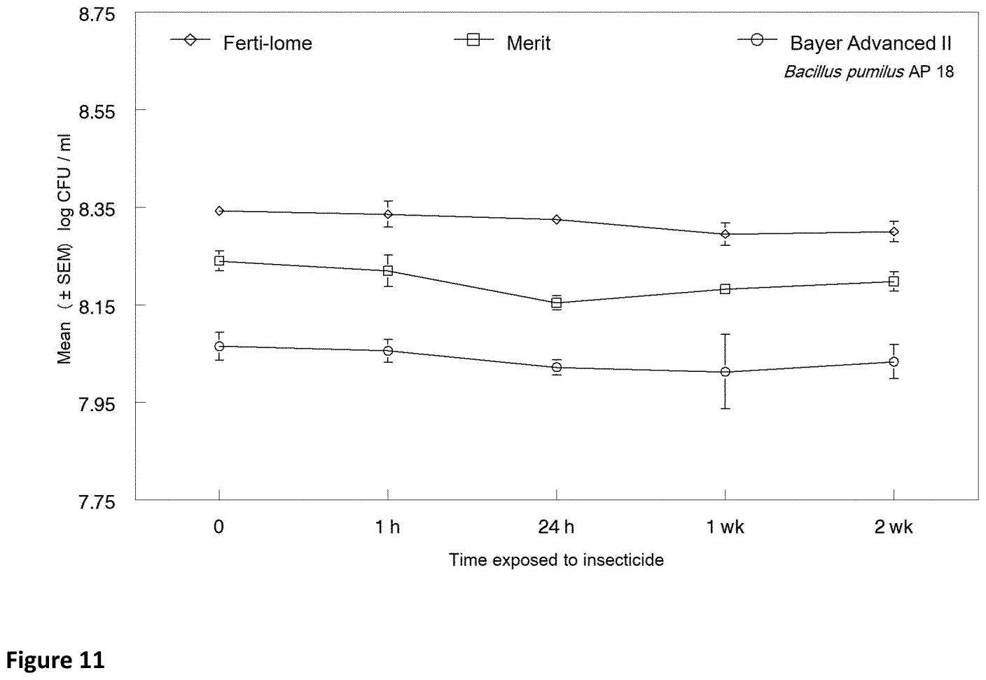

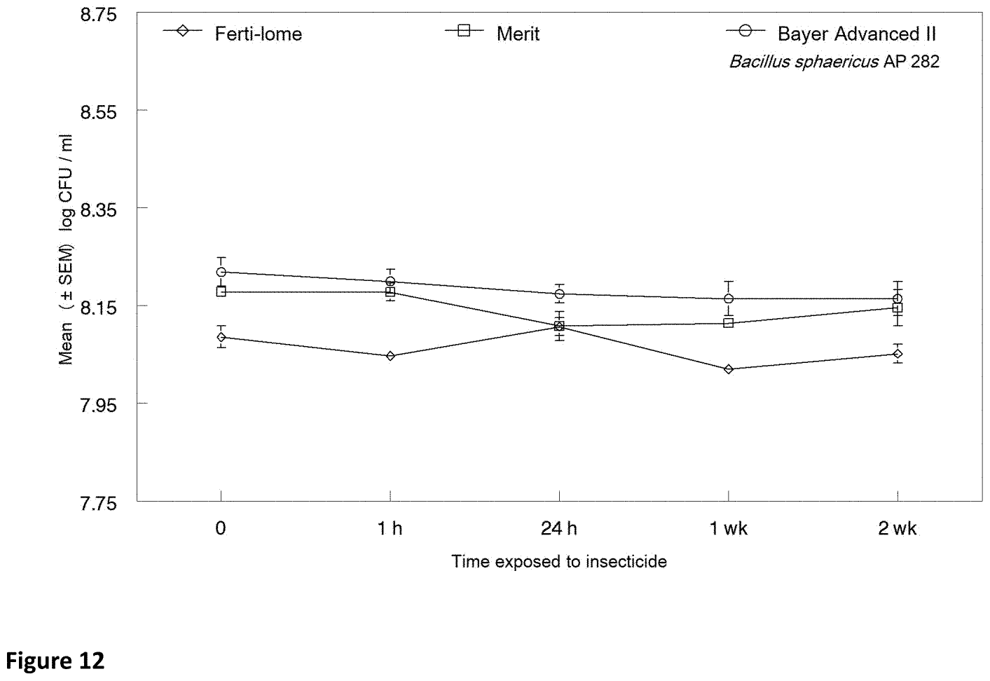

All strains within Blend 20 (B. pumilus AP 7, B. pumilus AP 18, and B. sphaericus AP 282) were mixed neonicotinoid with insecticides commonly used to control white grubs. Bacterial populations of all strains were not negatively impacted, remaining stable when mixed with the 1.47% formulation of imidacloprid (t=5.15, df=2, P≤0.0537). The mixture of B. pumilus AP 7 or B. pumilus AP 18 with 0.74% imidacloprid and 0.37% clothianidin for 2 wk did not negatively impact bacterial populations (t=3.29, df=2, P≤0.0812, FIGS. 10-12), but negatively impacted B. sphaericus AP 282 populations at 24 h (t=4.34, df=2, P=0.0492). All bacterial populations were negatively impacted during the experiment when mixed with the 21.4% formulation of imidacloprid (t=6.95, df=2, P≥0.0201) however, only B. pumilus AP 7 populations were negatively impacted at the end of 2 wk (t=6.1, df=2, P=0.0259).

3.3 Impacts of PGPR on Japanese Beetle Weight Gain and Survival

Recovery of live third instar white grubs in the tall fescue trial was 100% and 78.3% in the bermudagrass trial, with no treatment having less than 75% survival and recovery. Recovery of white grubs from non-treated bermudagrass was 75% and 80% for both PGPR-treated and nitrogen fertilized bermudagrass. Final weights of Japanese beetle grubs increased relative to initial weights in both trials. In the tall fescue trial, final larval weights ranged from 176.77-183.17 mg, and 142.5-164.94 mg in the bermudagrass trial. Final weights of white grubs in the tall fescue trial increased 267% (176.77 mg) for non-treated, 271% (180.83 mg) for PGPR-treated, and 275% (183.17 mg) for nitrogen fertilized tall fescue. The final weights of white grubs in the bermudagrass trial increased 310% (142.5 mg) for non-treated, 327% (151.19 mg) for PGPR-treated, and 356% (164.94 mg) for nitrogen treated bermudagrass. There were no significant differences between the non-treated, PGPR-treated, and nitrogen fertilized grass treatments on the final weights of grubs in either trial (tall fescue, F=0.158, df=2, 89, P=0.906; bermudagrass, F=1.76, df=2, 46, P=0.184).

3.4 Impact of Infested Arenas and Grass Growth

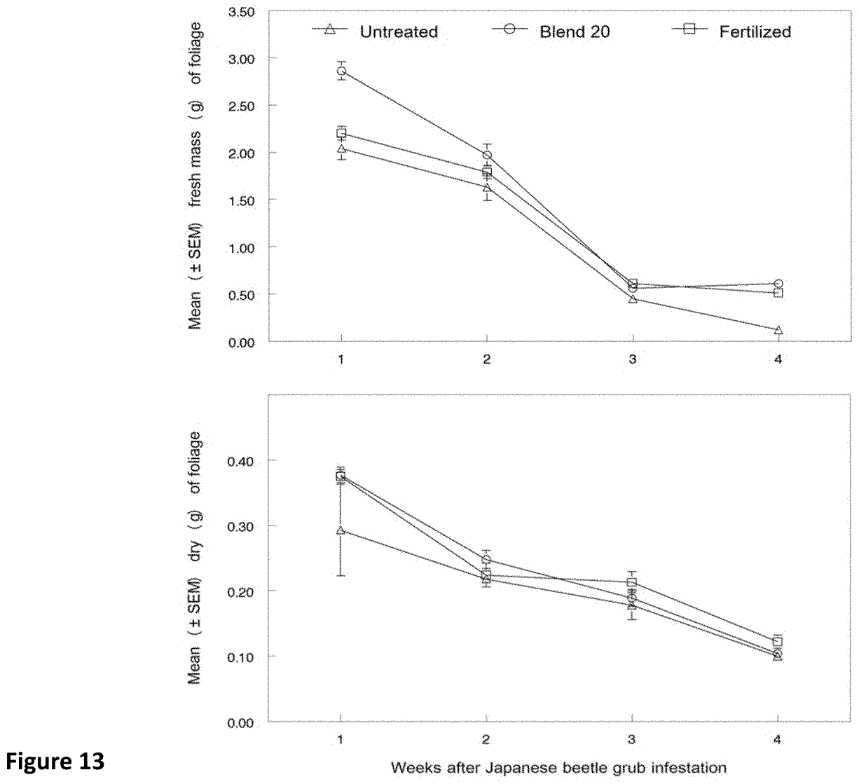

Top growth in containers infested with grubs declined over time with white grub infestation and the non-treated grasses produced the lowest shoot and root masses in both trials (Table 4, FIGS. 13,14).

TABLE 4
Mean (±SEM) of potted tall fescue (KY 32) and hybrid bermudagrass
(Tifway) root fresh and dry masses after 4 wk (KY 32) and 8 wk
(Tifway) of infestation with a single Japanese beetle white grub

| Trial | Cultivar | Treatment | FW (g) | | DW (g) | |
|---|---|---|---|---|---|---|
| Tall Fescue | KY 32 | Control | 9.24 ± | 0.5c | 2.09 ± | 0.27c |
| Tall Fescue | KY 32 | Nitrogen^{a} | 14.38 ± | 0.7b | 4.66 ± | 0.24b |
| Tall Fescue | KY 32 | Blend 20^{b} | 16.67 ± | 0.55a | 5.58 ± | 0.23a |
| Bermudagrass | Tifway | Control | 4.99 ± | 0.32b | 1.04 ± | 0.07b |
| Bermudagrass | Tifway | Nitrogen | 6.22 ± | 0.33ab | 1.33 ± | 0.08a |
| Bermudagrass | Tifway | Blend 20 | 7.30 ± | 0.42a | 1.51 ± | 0.09a |

Numbers presented are treatment means. For each trial, means in the same column followed by the same letter are not significantly different (P < 0.05; ANOVA, Student's t-test).
^{a}Grass fertilized with ammonium sulfate applied weekly at a rate of 5.81 g/m2 and infested with a single white grub.
^{b}Grass treated with Blend 20 (Bacillus pumilus AP 7, Bacillus pumilus AP 18, Bacillus sphaericus AP 282) applied weekly at a rate of 500 mL/m2 and infested with a single white grub.

In the fescue trial, differences in fresh masses of foliage were significant among treatments, but dry masses were not (fresh mass, F=12.04 df=2, 87, P<0.0001; dry mass F=0.24, df=2, 87, P=0.79). PGPR-treated tall fescue produced significantly more fresh mass than all other treatments (Orthogonal contrasts, F=23.75, df=1, 87, P<0.0001). Nitrogen fertilized grasses produced more fresh mass top growth than the non-treated tall fescue (F=3.74, df=1, 87, P=0.057).

In the bermudagrass trial, fertilized grasses produced significantly more fresh and dry mass of top growth than all other treatments (F≥19.13, df=2, 57, P<0.002). Both PGPR-treated and fertilized grasses had significantly more fresh and dry mass top growth than the non-treated bermudagrass over the 8 wk period (F≥18.05, df=1, 57, P≤0.0002). Fertilized grass produced significantly more fresh and dry top growth than the non-treated control (F≥24.79, df=1, 57, P≤0.0005). Treatment of bermudagrass with a nitrogen fertilizer resulted in significantly greater fresh top growth than treatment with PGPR (F=6.75, df=1, 57, P=0.012), but not greater dry mass (F=2.58, df=1, 57, P=0.11). Treatment of grass with PGPR resulted in significantly more fresh and dry top growth than the non-treated control (F≥5.74, df=1, 57, P=0.02).

Root fresh and dry mass were analyzed separately by trial (Table 1). PGPR-treated tall fescue and bermudagrass produced the greatest root fresh and drymass in both trials. PGPR-treatment of grass infested with Japanese beetle grubs produced fresh masses that were 146-180% greater and dry masses that were 145-267% greater than non-treated, infested grasses. Tall fescue treated either with PGPR or fertilizer produced significantly greater fresh and dry root mass than non-treated controls (F≥25.5, df=2, 89, P<0.0001). The treatment of tall fescue with PGPR resulted in significantly more fresh and dry root mass than fertilized tall fescue (F≥25.5, df=2, 89, P<0.029). Bermudagrass treated with PGPR resulted in significantly greater root fresh and dry mass than non-treated controls (F≥6.96, df=2, 59, P≤0.0006). Nitrogen fertilized grass resulted in significantly greater dry mass than non-treated bermudagrass (F≥6.96, df=2, 59, P≤0.055). PGPR-treated and fertilized bermudagrass produced fresh and dry masses that were similar and not significantly different (F≥6.96, df=2, 59, P≤0.226).

4. Discussion

White grubs are one of the key pests of grasses in pastures, lawns, golf courses, and sod production (1-3) As they consume the roots of their host, the grass becomes weakened, loses turgor, and can die. Because a larger root mass may enable grasses to tolerate damage from white grubs, this study provides evidence for sustained or enhanced growth of cool- and warm-season grass when treated with PGPR or a synthetic fertilizer and in the presence of root herbivory. While growth promotion in hybrid bermudagrass was expected based on previous work with Blend 20 (12,20) our study represents the first demonstration of growth promotion in tall fescue with a PGPR.

When infested with white grubs, foliar growth in both grasses declined steadily over time with treatment differences most apparent in the first week of each trial. In other greenhouse studies with bermudagrass (12) environment factors such as lighting can contribute to weekly declines in top growth over successive weeks of the experiment in the absence of root herbivory. This decline in top growth over time could either be due to environmental factors or reduced vigor during repeated re-growth, and not exclusively an effect of root herbivory. However, other greenhouse studies from our lab conducted using the same experimental protocols (unpublished data) in the absence of root herbivores, show consistent foliar growth in non-treated grasses over a 4-5 wk experiment. For these reasons, we attribute the decline in top growth over time is likely due to the high survival and increasing size of the white grubs, but cannot completely exclude environmental factors. Grub survival was ≥75% and not affected directly by the treatment, as noted in the grass trials and the separate topical and constant exposure experiments. Although we did not observe insecticidal effects or reduced survival, this should not be interpreted that PGPR lacks possible direct effects on white grubs. For example, when evaluated for effects on the fall armyworm, Spodoptera frugiperda JE Smith, certain blends of PGPR changed oviposition patterns of female moths but there was no consistent effect on larval and pupal weights (20). In previous work from our team, bermudagrass treated with Blend 20, the same bacteria used in this study, yielded greater fall armyworm pupal weights and shorter development time than the non-treated controls (20) Blend 20 induces larger root mass (12), however other rhizobacteria may induce greater shoot growth or have no effect (unpublished data). Rhizobacterial strains and blends have unique properties and this work should not be used to make broad generalizations about bacterial species used, root-feeding pest species, or pest life stage.

The treatment of grasses with PGPR does not appear to negatively affect the palatability of grass roots. On average, grubs tripled their mass overall, but the final weights and weight gain were not different between treatments. If root colonized by bacteria were unpalatable, lower survival and weight gains would be evident. Similarly, fungal endophyte experiments with P. japonica also do not show lower weights or survival on endophyte-infected grass.33 The greater root mass of the PGPR and fertilized grasses did not appear to produce greater mass of white grubs in those treatments. Studies, considering host plant resistance to white grubs among grasses,15-17 suggest that larger root systems in grasses produce larger white grubs. We did not find evidence of this in our experiment. This may be due to increased root production with bacteria-treated grasses. Tall fescue and bermudagrass infested with white grubs produced 12-15% greater root masses when treated with PGPR compared to fertilized, but only significantly greater root masses for PGPR treated tall fescue. A synthetic fertilizer was included to provide a control for greater root mass in both grass trials. In their review of microbe-plant-insect interactions, Pineda et al. (22) suggested that the effects of microbes on plants may be strengthened under biotic or abiotic stress.

The Bacillus spp. used to produce Blend 20 were typically compatible and stable when mixed with liquid formulations of neonicotinoid insecticides commonly used for the control of white grubs (FIGS. 10-12). Populations of all bacterial strains remained stable when mixed with the 1.47% formulation of imidacloprid. Only the combination of B. sphaericus AP 282 with the 0.74% imidacloprid and 0.37% clothianidin formulation negatively impacted populations at 24 h. While the combination of the 21.4% imidacloprid formulation negatively impacted populations of B. pumilus AP 18 and B. sphaericus AP 282 were negatively impacted at 24 h and 1 wk, respectively, only the final population of B. pumilus AP 7 was significantly different from the initial population. The significant decline in population of B. pumilus AP 7 at 24 h and 1 wk after mixing may indicate that the strain is negatively impacted by the prolonged exposure to imidacloprid at higher concentrations.

Variations in observed populations that differed significantly during the experiment, but not at the 2 wk observation period were likely a result from bacterial distribution in the centrifuge tubes, serial dilutions, and growth time of bacterial colonies on growth media. The greatest impact on bacterial populations was observed when the bacterial strains were mixed with the highest concentration of active ingredient. The combination of PGPR and insecticides for prolonged periods (2 wk) represents a scenario where the two tactics would either be mixed before application or interacting in the soil. The stability of the PGPR in Blend 20 mixed with certain insecticides is not surprising, given that Bacillus subtilus used with thiamethoxam in corn seeds increases pesticide uptake and plant growth (34). There does not appear to be products formulated containing both bacteria and pesticide(s), however our data suggest this approach may be a novel and integrated approach for pest management. With the environmental concerns over neonicotinoids used in agricultural and commodity crops, including turfgrasses, increased pesticide efficiency and post-treatment irrigation could alleviate some concerns and may enable lower use rates. As noted previously, the lack of negative consequence for particular rhizobacterial strains in Blend 20 when mixed with certain insecticide formulations should be interpreted cautiously. Other PGPR may not be compatible with all pesticides or inert ingredients in formulations. Populations of Pseudomonas fluorescens remained stable when mixed with the insecticides avermectin, carbofuran, chlorpyrifos, and endosulfan, but not with indoxacarb (35-38). PGPR populations may be more sensitive to fungicide exposure. Pseudomonas fluorescens populations were negatively impacted when mixed with the fungicides mancozeb, captan, propiconazole (35). Individual trials would be needed with different bacterial genera, strains, formulations and pesticides to determine compatibility.

In both grasses, our data suggest that bacteria or fertilizer can mitigate damage from root feeding white grubs relative to non-treated grasses with the same level of white grub infestation. While the use of bacterial biostimulants is a novel approach for mitigating damage from root-infesting pests in turfgrass, the use of fertilizer or plant hormones to alleviate stress from root-feeding has been noted previously (39,40). Blanco-Montero and Ward (40) evaluated weekly applications of commercial cytokinin products that increased root biomass of Kentucky bluegrass (Poa pratensis L.). The grass infested with masked chafer (Cyclocephala pasadenae Casey) grubs that received these treatments compensated for the white grub feeding compared to infested and non-infested bluegrass. Commercially-available PGPR products (e.g., Nortica, Bayer Environmental Sciences) are available for use in turfgrass but the labeling of those products does not currently include stress mitigation due to root feeding insects. The present study and other work in our lab suggest that biofertilization with PGPR may have potential for integrated pest management of root-feeding herbivores.

### References

1 Williamson R C, Held D W, Brandenburg R and Baxendale F, Turfgrass insect pests, in Turfgrass Monograph, 3rd edn, ed. by Stier J S, Bonos S and Horgan B. American Society of Agronomy, Madison, Wis., pp. 809-890 (2013).
2 Flanders K L, DeLamar ZDand Lago P K, Phyllophaga and related species (Coleoptera: Scarabaeidae) collected in black-light traps in Alabama pastures. J Entomol Sci 35:311-326 (2000).
3 Potter D A, Destructive Turfgrass Insects: Biology, Diagnosis, and Control. Ann Arbor Press, Chelsea Mich., p. 344 (1998).
4 McCurdy J D, Held D W, Gunn J M and Barickman T C, Dew from warm-season turfgrasses as possible rout for pollinator exposure to lawn-applied imidacloprid. Crop Forage Turf Manag 3 (2017). https://doi.org/10.2134/cftm2016.09.0063.
5 Larson J L, Redmond C T and Potter D A, Mowing mitigates bioactivity of neonicotinoid insecticides in nectar of flowering lawn weeds and turfgrass guttation. Environ Toxicol Chem 34:127-132 (2015).
6 Larson J L, Redmond C T and Potter D A, Assessing insecticide hazard to bumble bees foraging on flowering weeds in treated lawns. PLoS One 8:e66375 (2013). https://doi.org/10.1371/journal.pone.0066375.
7 Peck D C, Long-term effects of imidacloprid on the abundance of surface- and soil-active nontarget fauna in turf. Agric Forest Entomol 11:405-419 (2009).
8 McKersie B, Planning for food security in a changing climate. J Exp Botany 66:3435-3450 (2015).
9 Held D W and Potter D A, Prospects for managing turfgrass pests with reduced chemical inputs. Annu Rev Entomol 57:329-354 (2012).
10 Breen J B, Acremonium endophyte interactions with enhanced resistance to insects. Annu Rev Entomol 39:401-423 (1994).
11 Grewal P S, Lewis E E, Gaugler R and Campbell J F, Host finding behavior as a predictor of foraging strategy in entomopathogenic nematodes. Parasitology 108:207-215 (1994).
12 Coy R M, Held D W and Kloepper J W, Rhizobacterial inoculants increase root and shoot growth in ‘Tifway’ hybrid bermudagrass. J Environ Hort 32:149-154 (2014).
13 Kasim W W, Osman M E, Omar M N, Ebd El-Daim I A, Bejai S and Meijer J, Control of drought stress in wheat using plant-growth-promoting bacteria. J Plant Growth Reul 32:122-130 (2012).
14 Omar M N, Fang P and Jia X M, Effect of inoculation with Azospirillum brasilense NO40 isolated from Egyptian soil on rice growth in China. Egypt J Agric Res 78:1005-1014 (2000).
15 Bughrara S S, Smitley D R and Cappaert D, European chafer grub feeding on warm-season and cool-season turfgrasses, native prairie grasses, and Pennsylvania sedge. HortTechnology 18:329-333 (2008).
16 Braman S K and Raymer P L, Impact of Japanese beetles (Coleoptera: Scarabaeidae) feeding on seashore Paspalum. J Econ Entomol 99:1699-1704 (2006).
17 Bughrara S S, Smitley D R, Cappaert D and Kravchenko A N, Comparison of tall fescue (Cyperale: Gramineae) to other cool-season turfgrasses for tolerance to European chafer (Coleoptera: Scarabaeidae). J Econ Entomol 96:1898-1904 (2003).
18 Bakker P A H N, Doornbos R M, Zamioudis C, Berendsen R L and Pieterse C M J, Induced systemic resistance and the rhizosphere biome. Plant Pathol J 29:136-143 (2013).
19 Kloepper J W, Ryu C M and Zhang S, Induced systemic resistance and promotion of growth by Bacillus spp. Phytopathology 94:1259-1266 (2004).
20 Coy R M, Held D W and Kloepper J W, Bacterial inoculant treatment of bermudagrass alters ovipositional behavior, larval and pupal weights of the fall armyworm (Lepidoptera: Noctuidae). Environ Entomol 46:831-838 (2017).
21 Biere A and Bennett A E, Three-way interactions between plants, microbes, and insects. Funct Ecol 27:567-573 (2013).
22 Pineda A, Dicke M, Pieterse C M J and Pozo M J, Beneficial microbes in a changing environment: are they always helping plants to deal with insects? Funct Ecol 27:574-586 (2013).
23 Pineda A, Zheng S J, van Loon J J A and Pieterse C M J, Rhizobacteria modify plant-aphid interactions: a case of induced systemic susceptibility. Plant Biol 14:83-90 (2012).
24 Pineda A, Zheng S J, van Loon J J A, Pieterse C M J and Dicke M, Helping plants to deal with insects: the role of beneficial soil-bornemicrobes. Trends Plant Sci 15:507-514 (2010).
25 Zehnder G W, Murphy J F, Sikora E J and Kloepper J W, Application of rhizobacteria for induced resistance. Eur J Plant Pathol 107:39-50 (2001).
26 Zehnder G, Kloepper J, Yao C and Wei G, Induction of systemic resistance against cucumber beetles (Coleoptera: Chrysomelidae) by plant growth-promoting rhizobacteria. J Econ Entomol 90:391-396 (1997).
27 USDA-APHIS, Managing the Japanese beetle. A Homeowner's Handbook. US Dept. Agric. http://www.pueblo.gsa.gov/cictext/housing/japanese-beetle/jbeetle.html (2015).
28 Crutchfield B A and Potter D A, Feeding by Japanese beetle and southern masked chafers on lawn weeds. Crop Sci 35:1681-1684 (1995).
29 Crutchfield B A and Potter D A, Tolerance of cool-season turfgrasses to feeding by Japanese beetle and southern masked chafer (Coleoptera: Scarabaeidae) grubs. J Econ Entomol 88:1380-1387 (1995).
30 Crutchfield B A and Potter D A, Irrigation and nitrogen fertilization effects on white grub injury to Kentucky bluegrass and tall fescue turf. Crop Sci 35:1122-1126 (1995).
31 Fleming W E, Integrating control of the Japanese beetle—a historical review. USDA Tech Bull 1449: p. 129 (1976).
32 Fleming W E, Biological control of the Japanese beetle USDA Tech Bull 1383: p. 78 (1968).
33 Koppenhofer A M, Cowles R S and Fuzy E M, Effects of turfgrass endophytes (Clavicipitaceae: ascomycetes) on white grub (Coleoptera: Scarabaeidae) larval development and field populations. J Environ Entomol 32:895-906 (2003).
34 Myresiotis C K, Vryzas Z and Papadopoulou-Mourkidou E, Effect of specific plant-growth-promoting rhizobacteria on growth and uptake of neonicotinoid insecticide thiamethoxam in corn (Zea mays L.) seedlings. Pest Manag Sci 71:1258-1266 (2015).
35 Patil B V, Naik M K, Manujnath H and Hosamani A C, Formulation and compatibility of PGPR with pesticides for suppression of insect pests, in Recent Advances in biofertilzers and biofungicides for sustainable agriculture, ed. by Reddy M S, Ilao R O and Faylon P S. Cambridge Scholars Publishing, Dar, and Batchelor W D, pp. 269-280 (2014).
36 Kumar K, Santharam G and Sridhar R, Compatibility of imidacloprid with plant pathogenic antagonistic microorganisms, Trichoderma viride (Pers) and Pseudomonas fluorescens (Migula) in cotton. Asian Biol Sci 3:171-175 (2008).
37 Jayakumar J, Ramakrishnan S and Rajendran G, Evaluation of Pseudomonas fluorescens strains isolated from cotton rhizosphere against Rotylenchus reniformis. Indian J Nematol 34:206-208 (2004).
38 Khan M A and Gangopadhyay S, Efficacy of Pseudomonas fluorescens in controlling root rot of chickpea caused by Macrophomina phaseolina. J Mycol Plant Pathol 35:580-587 (2008).
39 Smitley D R, European chafer damage is evident. Michigan State Univ Landscap Crop Advisory Team Alert 13:2 (1998).
40 Blanco-Montero C A and Ward C R, Mitigation effects of cytokinin plant growth regulator on turfgrass root-biomass loss by white grubs. Southwestern Entomologist 20:11-15 (1995).

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

Citations to a number of patent and non-patent references are made herein. The cited references are incorporated by reference herein in their entireties. In the event that there is an inconsistency between a definition of a term in the specification as compared to a definition of the term in a cited reference, the term should be interpreted based on the definition in the specification.

We claim:

1. A composition for promoting plant health and growth in a plant, the composition comprising and effective amount of: (i) one or more plant growth promoting-rhizobacteria (PGPR); and (ii) one or more insecticides; wherein the composition promotes health and growth when the composition is administered to a plant.

2. The composition of claim 1, wherein the PGPR are selected from bacteria belonging to a genera selected from the group consisting of Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, and Lysinibacillus.

3. The composition of claim 1, wherein the PGPR belong to the genus Bacillus.

4. The composition of claim 1, wherein the PGPR are selected from the group consisting of B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altitudinis, B. alveayuensis, B. amyloliquefaciens, B. anthracis, B. aquimaris, B. arsenicus, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyticus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. fastidiosus, B. firmus, B. flexus, B. foraminis, B. fordii, B. fortis, B. fumarioli, B. funiculus, B. galactosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. krulwichiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus, B. qingdaonensis, B. rigui, B. ruris, B. safensis, B. salarius, B. saliphilus, B. schlegelii, B. selenatarsenatis, B. selenitireducens, B. seohaeanensis, B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. thermoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and mixtures or blends thereof.

5. The composition of claim 1, wherein the composition comprises a mixture of PGPR.

6. The composition of claim 1, wherein the composition comprises the PGPR at a concentration of at least about 1×10⁵ colony forming units (CFU)/ml.

7. The composition of claim 1, wherein the insecticide comprises one or more neonicotinoids.

8. The composition of claim 1, wherein the insecticide comprises one or more neonicotinoids selected from the group consisting of acetamiprid, clothianidin, imidacloprid, nitenpyram, nithiazine, thiacloprid and thiamethoxam.

9. The composition of claim 1, wherein the insecticide comprises one or more neonicotinoids at a concentration of at least about 1%.

10. The composition of claim 1, wherein the insecticide comprises one or more phenypyrazoles.

11. The composition of claim 1, wherein the insecticide comprises one or more phenypyrazoles selected from the group consisting of acetoprole, ethiprole, fipronil, flufiprole, pyraclofos, pyrafluprole, pyriprole, pyrolan, and vaniliprole.

12. The composition of claim 1, wherein the insecticide comprises one or more phenypyrazoles at a concentration of at least about 1%.

13. The composition of claim 1, wherein insecticide comprises one or more pyrethroids.

14. The composition of claim 1, wherein insecticide comprises one or more pyrethroids selected from the group consisting of allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, metofluthrin, permethrin, resmethrin, silafluofen, sumithrin, tau-Fluvalinate, tefluthrin, tetramethrin, tralomethrin, and transfluthrin.

15. The composition of claim 1, wherein the insecticide comprises one or more pyrethroids at a concentration of at least about 1%.

16. The composition of claim 1 further comprising a nitrogen-containing fertilizer.

17. A method for increasing tolerance to damage from root-feeding pests in a plant in need thereof, the method comprising administering to the plant, to seeds of the plant, or to soil surrounding the plant, a composition comprising an effective amount of a plant growth-producing rhizobacteria (PGPR) and an effective amount of an insecticide for increasing tolerance to damage from the root-feeding pests in the plant.

18. The method of claim 17, wherein the plant is selected from bermudagrasses (Cynodon spp.), bahiagrass (Paspalum notatum Flugge), Saint Augustinegrass (Stenotaphrum secundatum (Walt) Kuntz), centipedegrass (Eremochloa ophiuroides (Munro) Hack), and zoysiagrass (Zoysia spp.).

19. A method for increasing tolerance to drought in a plant in need thereof, the method comprising administering to the plant, to seeds of the plant, or to soil surrounding the plant, a composition comprising an effective amount of a plant growth-producing rhizobacteria (PGPR) and an effective amount of an insecticide for increasing tolerance to drought in the plant.

20. The method of claim 19, wherein the plant is selected from bermudagrasses (Cynodon spp.), bahiagrass (Paspalum notatum Flugge), Saint Augustinegrass (Stenotaphrum secundatum (Walt) Kuntz), centipedegrass (Eremochloa ophiuroides (Munro) Hack), and zoysiagrass (Zoysia spp.).
